(19) United States
(12) Patent Application Publication
(10) Pub. No.: US 2019/0261654 A1
(43) Pub. Date: Aug. 29, 2019

(54) CROSS-COUPLED REGIONS FOR PASTEURIZATION AND PASTEURIZATION METHODS USING SYNCHRONIZED PEAK ELECTRIC AND MAGNETIC FIELDS

(71) Applicant: Xinova, LLC., Seattle, WA (US)

(72) Inventor: Kevin S. Fine, (US)

(73) Assignee: Xinova, LLC, Seattle, WA (US)

(21) Appl. No.: 16/304,049

(22) PCT Filed: May 17, 2017
(86) PCT No.: PCT/US2017/033115

§ 371 Date: Nov. 21, 2018

Related U.S. Application Data
(60) Provisional application No. 62/342,093, filed on May 26, 2016.

(51) Int. Cl. A23L 3/005; A23B 7/005; A23B 9/04; H05B 6/06

(52) U.S. Cl. CPC A23L 3/005; A23B 7/005; H05B 6/107; H05B 6/06; A23B 9/04

(57) ABSTRACT

Pasteurization systems, devices and methods are generally described that use synchronized peak electric and magnetic fields. Example pasteurization systems may include a first resonant circuit that includes a first capacitive element coupled to a first inductive element, a second resonant circuit that includes a second capacitive element coupled to a second inductive element. The first inductive element and the second capacitive element may be positioned about the first treatment region, and the second inductive element and the first capacitive element may be positioned about the second treatment region. A controller coupled to the first and second resonant circuits may provide a first signal to the first resonant circuit and a second signal to the second resonant circuit, phase shifted by a predetermined amount.

CROSS-REFERENCE TO RELATED APPLICATION

This application claims the benefit under 35 U.S.C. 119(e) of the earlier filing date of U.S. Provisional Application No. 62/342,093 filed May 26, 2016, which is incorporated by reference, in its entirety, for any purpose.

### BACKGROUND

Unless otherwise indicated herein, the materials described in this section are not prior art to the claims in this application and are not admitted to be prior art by inclusion in this section.

Bacteria found in food may cause various problems ranging from illness to short shelf life. Pasteurization is used to eliminate the bacteria, but the manner in which pasteurization is performed may have drawbacks. For example, heating the food may eliminate some or all of the bacteria, but the heat may also alter the foods for the worse. Applying direct current to foods has been shown to eliminate bacteria, but food tends to breakdown due to high currents, which may lead to the creation of carcinogenic compounds and bad taste, for example. Additionally, the state of the food being pasteurized may affect the technique used to perform the pasteurization. For example, liquid foods may present problems based on various characteristics, such as salinity, pH, temperature, and formation of bubbles.

Liquid foods have been pasteurized with pulsed electric fields, but the maximum voltage applied may be limited by the breakdown voltage of the liquid. For example, salty beverages, tomato juice for example, may have a low breakdown due to the high salt content. While pulsing the electric fields allows for exposing the liquid foods to higher electric potentials due to the short life of the pulse, the maximum electric field may still be limited due to breakdown. This limited potential may not eliminate as much bacteria as would be desirable.

### SUMMARY

Techniques are generally described that include methods and systems. An example system may include a first resonant circuit that includes a first capacitive element coupled to a first inductive element, and a second resonant circuit that includes a second capacitive element coupled to a second inductive element. A first region receives a first substance, where the first inductive element and the second capacitive element are positioned to form the first region, and a second region receives a second substance, where the second inductive element and the first capacitive element are positioned to form the second region. A controller is coupled to the first and second resonant circuits and configured to provide a first signal to the first resonant circuit and a second signal to the second resonant circuit, where the first and second signals may be phase shifted by a predetermined amount. The controller is further configured to control the first signal effective to promote pasteurization of the first substance in the first region, and also configured to control the second signal effective to promote pasteurization of the second substance in the second region.

In some examples, the system further includes a first conduit extending through the first region and configured to provide the first substance to the first region, wherein the first conduit comprises an inner portion having a central axis and an outer portion located about the central axis. In some examples, the second capacitive element is arranged around at least a portion of the first conduit, and wherein the first inductive element is arranged around the first capacitive element and around at least the portion of the first conduit. In some examples, the second capacitive element is configured as a coaxial capacitor having an inner conductor extending along at least a portion of the central axis of the first conduit and an outer conductor arranged around at least the portion of the first conduit. In some examples, the second capacitive element is configured as a parallel plate capacitor comprising a first plate arranged on one side of at least a portion of the first conduit, and a second plate arranged at substantially an opposite side of at least the portion of the first conduit.

In some examples, the system further includes a second conduit extending through the second region and configured to provide the second substance to the second region, wherein the second conduit comprises an inner portion having a central axis and an outer portion located about the central axis. In some examples, the first capacitive element is arranged around a portion at least a portion of the second conduit, and wherein the second inductive element is arranged around the first capacitive element and around at least the portion of the second conduit. In some examples, the first capacitive element is configured as a coaxial capacitor having an inner conductor extending along at least a portion of the central axis of the second conduit and an outer conductor arranged around at least the portion of the second conduit. In some examples, the first capacitive element is configured as a parallel plate capacitor comprising a first plate arranged on one side of at least a portion of the second conduit, and a second plate arranged at substantially an opposite side of at least the portion of the second conduit.

In some examples, the first inductive element and the second capacitive element are positioned about the first region such that in response to first and second signals provided by the controller, a magnetic field is generated by the first conductive element in the first treatment region and an electric field is generated by the second capacitive element in the first treatment region. In some examples, the magnetic field is substantially orthogonal to the electric field in the first treatment region. In some examples, the magnetic field and the electric field in the first region are configured to simultaneously reach maximum field strengths.

In some examples, the second inductive element and the first capacitive element are positioned about the second region such that in response to first and second signals provided by the controller, a magnetic field is generated by the second conductive element in the second treatment region and an electric field is generated by the first capacitive element in the second treatment region. In some examples, the magnetic field is substantially orthogonal to the electric field in the second treatment region. In sonic examples, the magnetic field and the electric field in the first region are configured to simultaneously reach maximum field strengths.

An example method may include at a first time, generating a first magnetic field and a first electric field in a first treatment region, wherein a direction of the first magnetic field and a direction of the first electric field are substantially orthogonal with respect to one another within the first treatment region. The example method may also include at a second time, generating a second magnetic field and a second electric field in a second treatment region, wherein a direction of the second magnetic field and a direction of the second electric field are substantially orthogonal with respect to one another within the second treatment region.

In some example methods, generating a first magnetic field and a first electric field in a first treatment region and generating a second magnetic field and a second electric field in the second treatment region may further include providing a first oscillating signal to a first resonant circuit that includes a first inductive element positioned to provide a magnetic field in the first treatment region and a first capacitive element positioned to provide an electric field in the second treatment region, and providing a second oscillating signal to a second resonant circuit that includes a second capacitive element positioned to provide an electric field in the first treatment region and a second inductive element positioned to provide a magnetic field in the second treatment region, wherein the first and second oscillating signals are 90-degrees out of phase.

In some example methods, the method may further include sensing a first magnetic field strength and a first electric field strength in the first region, providing feedback based on values of the sensed first magnetic field strength and the sensed first electric field strength in the first region, and adjusting the first or second signals used to generate the first magnetic field and the first electric field in the first treatment region based on the feedback.

In some example methods, the method may further include sensing a second magnetic field strength and a second electric field strength in the second region, providing feedback based on values of the sensed second magnetic field strength and the sensed second electric field strength in the second region, and adjusting oscillating signals used to generate the second magnetic field and the second electric field in the second treatment region based on the feedback.

In some example methods, the method may further include flowing a substance to be pasteurized through the first and second treatment regions during the first and second times, and pulsing the first and second peak electric fields and the first and second peak magnetic fields.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1A is a schematic illustration of an example system 100 arranged in accordance with at least some embodiments described herein;

FIG. 1B is a schematic illustration of the relation and direction of the magnetic and electric fields the example system 100 generates in accordance with at least some embodiments described herein;

FIG. 1C is an illustration of an example system 150 arranged in accordance with at least some embodiments of the present disclosure;

FIG. 2A shows two cross-sectional views of a capacitive element 200, which may be used to implement the capacitive element 106 of FIG. 1A;

FIG. 2B shows two cross-sectional views of a capacitive element 250 which may be used to implement the capacitive element 106 of FIG. 1A;

FIGS. 3A through 3C are schematic illustrations of various example configurations for conduits, capacitive elements and inductive elements in accordance with at least some embodiments of the present disclosure

FIG. 4 is a schematic illustration of a pasteurization system 400 arranged in accordance with at least some embodiments described herein;

FIG. 5A is a schematic illustration of portions of the pasteurization system 200 of FIG. 2 arranged in accordance with examples described herein;

FIG. 5B is an example physical arrangement 525 of the two resonant circuits 510, 512 in accordance with at least some embodiments discussed herein;

FIG. 5C is a timing diagram showing electric and magnetic field amplitudes in the treatment regions 204 and 206 over time in accordance with some examples described herein;

FIG. 6 is a flow chart illustrating an example method 600 for pasteurization in accordance with at least some embodiments described herein;

FIG. 7 is a block diagram illustrating an example computing device 700 that is arranged for controlling a pasteurization system in accordance with at least some embodiments described herein; and

FIG. 8 is a block diagram illustrating an example computer program product 700 that is arranged to store instructions for a pasteurization system in accordance with at least some embodiments described herein;

all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are implicitly contemplated herein.

This disclosure is drawn, inter alia, to methods, systems, products, devices, and/or apparatuses including, for example, food pasteurization systems that include a first region, a second region, and control circuitry. Electrical components associated with the first and second regions may be cross-coupled, for example by coupling an inductance of the first region to a capacitance of the second region and vice-versa. Control circuitry may apply phase-shifted drive signals to the cross-coupled circuits, which may result in synchronized pulsed electric and magnetic fields occurring in both regions such that the peak electric and magnetic fields in the first region occur substantially at a same time. Moreover, the peak electric and magnetic fields in the second region may also occur at the same time, although that time in the second region may be different than the peak time in the first region. By providing peak electric and magnetic fields at the same time in a treatment region, a synergistic effect may be realized in some examples such that a greater amount of bacteria or other species may be killed than expected in view of either the electric or magnetic field alone in some examples. In some examples, the synergistic effect may allow for lower overall power levels, which may lead to less damage to the liquids being treated.

As discussed above, pasteurization of foods, especially liquid foods such as juices, milk, liquid eggs, etc., may be performed using pulsed electric fields (PEFs). The voltage level of the PEF, however, may be limited due to dielectric breakdown of the foods. Due to the breakdown limitation, the amount of pasteurization, e.g., the number of bacteria killed, may be limited. The limits on the number of bacterial killed may, for example, limit the shelf life of the foods and may further require the incorporation of preservatives, which may be undesirable. In addition to PEF, pulsed magnetic fields (PMF) have also been shown to provide bacteria killing properties. The bacterial killing properties of PMF may be similar to those achieved by PEF with respect to bacterial kill rate, log 2 for example. While pasteurizing foods with PEF and PMF may be done in various orders, the manner in which the combined application of PEF and PMF may affect the end results. For example, performing PEF and PMF separately on the same food may only slightly improve the overall pasteurization over either performed alone. However, if PMF and PEF are performed simultaneously with their respective fields normal to each other, and under certain conditions, a synergistic effect may be obtained that provides a greater kill rate than the two techniques performed separately or serially.

The synergy generated between the electric and magnetic fields in some examples may be due to a magnetic insulation effect that occurs due to the magnetic field. For example, magnetic insulation may occur in gaseous mediums due to the presence of magnetic fields, where gas bubbles tend to be the location breakdown occurs due to high electric fields. The magnetic insulation effect may increase the breakdown voltage by changing the path electrons move within the gas. In the presence of both an electric and magnetic field, an electron may move in a circular path due to the interaction of the two fields, whereas an electron may only move in a linear path along the electric field when no magnetic field is present. The change in path may further be influenced by the orientation of the magnetic field to the electric filed, which may affect a shape of the path an electron traverses. The orientation of the two fields may affect how the fields interact and the combined influence the fields have on an electron. In some examples, the interaction between the two fields may be at a maximum when the two fields are orthogonal, which may cause the path an electron traverses in a bubble to be a tight circle or spiral. Non-orthogonal relationships between the two fields may cause an electron to traverse paths of other shapes. As has been determined, breakdown in liquids due to high electric fields tends to occur at bubbles present in the liquids before propagating into the liquid, as opposed to the liquid itself breaking down. As such, the magnetic insulation effect may increase breakdown within liquids by increasing the breakdown voltage of gas bubbles within the liquids due to the changed path the electrons traverse in the presence of the magnetic field. While breakdown of the liquids may not be eliminated, the breakdown may be increased enough so that liquids may be exposed to higher electric fields than would otherwise be possible.

The reduced breakdown voltage of bubbles within liquids due to the magnetic insulation effect may be capitalized on in PEF-based pasteurization systems. Liquids may have a higher breakdown voltage when exposed to pulsed electric fields than when exposed to continuous electric fields, which may improve the effectiveness of the pasteurization. As noted, the pasteurization rate of a PEF-based pasteurization system may obtain kill rates of log 2, which is useful, but higher kill rates, such as log 4 or log 5, may be desired. For comparison, a log 2 kill rate implies that 99 bacteria out of every 100 are killed, whereas log 4 implies 9,999 out of 10,000 bacteria are killed. While increasing the peak voltage of the PEF may improve the kill rate, the liquids exposed to the higher electric field may breakdown resulting in undesirable characteristics, such as bad taste or the formation of carcinogenic compounds within the liquids. Thus, to improve the kill rate without undesirably affecting the liquids, liquids may be pasteurized using synchronized PEF and PMF to increase the breakdown level of the treated foods, which may in sonic examples be due at least in part to the magnetic insulation effect. As used herein, synchronized may refer to the electric and magnetic fields reaching their maximum substantially at the same time. BY synchronizing magnetic and electric fields in a treatment region, foods may be exposed to higher electric fields without experiencing breakdown, which may allow the pasteurization system to reach a log 4 or log 5 kill rate in some examples.

Generally, pulsed electric and magnetic fields may be generated using a resonant circuit. Resonant circuits, which are sometimes referred to as tank circuits or tuned circuits, are electrical circuits that typically include an inductor (L) that is coupled to a capacitor (C), where the components are selected to operate at a tuned or resonant frequency, f which may be given as f=1/(2π\sqrt{LC}). The frequencies applied, for example, may be from 1 Hz to several 10's of gigahertz. In some examples, the frequencies applied may be from 1 Hz to 100 kHZ. In some examples, the frequencies applied may be from 100 kHz to 10 MHz. In some examples, the frequencies applied may be from 10 MHz to 10 GHz. In some examples the frequencies applied may be from 100 kHz to 1 GHz. In sonic examples, the frequencies applied may be from 500 kHz to 1 MHz. Although the inductor and capacitor may be depicted as single components, these are merely illustrative and any collection of components or circuits will also suffice. Thus, a single capacitor represented in a circuit may be implemented as either an individual component or a collection of components that may be active or passive, where the capacitor has an effective capacitance value simply referred to as capacitance. Similarly, a single inductor represented in a circuit may be implemented as either an individual component or a collection of components that may be active or passive or a combination thereof, where the inductor has an effective inductance value simply referred to as inductance.

Another resonant circuit may include an inductor, a capacitor and a resistor that are series-coupled together. Similar to the LC circuit described above, the resonant frequency of the RLC circuit is given as f=1/(2π\sqrt{LC}) with addition of a damping factor, ζ, that may be caused by the resistance from the resistor, R, where the damping factor is given as

$$ζ = \frac{R}{2} \sqrt{\frac{C}{L}} .$$

The damping factor may be a characteristic of energy loss of the circuit, where resistance of the circuit may provide resistive losses, I²R losses, which may also be referred to as heating losses. Similar to the inductors and capacitors described above, the resistor can be implemented as either an individual component or a collection of components that may be active or passive or a combination thereof, where the resistor has an effective resistance value simply referred to as resistance. Capacitors and inductors may also have a parasitic resistance value which may be modelled as a resistor, and thus no physical resistor may be present in the implemented RLC circuit since it is already part of the other components as parasitic resistance.

Resonant circuits may generally operate by recycling power back and forth between an inductance and a capacitance, where energy may be lost through resistive losses. The resistive losses may include parasitic resistances associated with the capacitance and inductance along with other resistive elements present in the circuit. Energy input may charge the capacitance, providing an electric field, while the inductance may operate as a short. In this state, the inductance may not provide a magnetic field. If the energy is continuously provided, the capacitance may remain charged and the inductance may remain a short. However, if the energy source is removed, the energy in the capacitance may begin to flow into the inductance in the form of current, which may begin to generate a magnetic field. As such, resonant circuits generally produce electric fields that are out of phase with corresponding magnetic fields generated by the circuit due to the energy oscillating between the capacitance and the inductance. Generally, without considering resistive losses, the energy would continue to oscillate between the capacitance and the inductance. However, parasitic resistances of the LC circuit may slowly drain the energy of the circuit due to, for example, Joule heating, e.g., I²R losses. In some examples, energy may be input into an LC circuit using a drive signal, which may be an oscillation signal, such as a square wave, sine wave, triangular wave, a pulsed DC signal, etc.

In some examples described herein, multiple (e.g. two) treatment chambers, which may correspond with two treatment regions described herein, may be formed by electrical components that may be cross-coupled so that the capacitance associated with one treatment chamber is coupled with an inductance associated with another treatment chamber, which may define a treatment region in each chamber. For example, capacitance of a first treatment chamber may be coupled to an inductance associated with a second treatment chamber. Similarly, an inductance associated with the first treatment chamber may be coupled to a capacitance associated with the second treatment chamber. The capacitance associated with the first treatment chamber and the inductance associated with the second treatment chamber may form at least a portion of a first resonant circuit. The inductance associated with the first treatment chamber and the capacitance associated with the second treatment chamber may form at least a portion of a second resonant circuit. Stated another way, two resonant circuits may be physically associated so that a capacitance of the first resonant circuit is physically co-located with an inductive element of the second resonant circuit. Similarly, an inductance of the first resonant circuit is physically co-located with a capacitance of the second resonant circuit. By physically locating the capacitance and inductance of the first and second resonant circuits as described, the electric and magnetic fields generated by the two resonant circuits may be generated in the same physical space and at the same time. The physical space, e.g., a volume of space, where the electric and magnetic fields are simultaneously present may form a region configured to pasteurize food substances. A chamber, which may be implemented as a conduit, a vessel, a tube, a vat, or other containers, may contain one or more treatment regions depending on the positioning of the components used to generate fields for pasteurization. Simultaneously may refer generally to events occurring at about the same time. For example, the electric and magnetic fields may be present at the precise same time, or may be present within several microseconds, milliseconds, or seconds of one another.

Drive signals may be provided to the first and second resonant circuits that cause an electric field generated by the capacitance associated with a first treatment region to coincide with a magnetic field generated by the inductance associated with the first treatment region even though the capacitance and the inductance associated with the first treatment region are not part of the same resonant circuit. Further, an electric field generated by the capacitance associated with the second treatment region may coincide with a magnetic field generated by the inductance associated with the second treatment region. For example, the respective drive signals provided to the first and second resonant circuits may be out of phase with one another. For example, if the respective drive signals are sine waves, then the respective sine waves may be provided 90-degrees out of phase such that the electric field provided by the capacitance associated with the first treatment region (e.g. the capacitance of a first resonant circuit) occurs at substantially a same time as the magnetic field provided by the inductance associated with the first treatment region (e.g. the inductance of a second resonant circuit). In some examples, the signals may be provided at different degrees out of phase, such 89, 88, 87, 86, 85, 84, 83, 82, 81, or 80 degrees out of phase. Other phase shifts may also be used that achieve generally peak simultaneous electric and magnetic fields in the treatment regions, which generally may refer to electric and magnetic fields of sufficient strength to achieve pasteurization. In some examples, where signals are applied to control a capacitance and inductance associated with a single treatment region, the signals may not be out of phase, and may have a same phase.

While some of the embodiments discussed herein may depict two separate treatment regions, e.g., in a parallel layout, the physical orientation of the two treatment regions is used for ease of explanation and should not be taken as a limiting factor. Any physical orientation of cross-coupled oscillator circuits is contemplated and covered by the present disclosure. In some embodiments, a conduit may extend through the area where synchronized electric and magnetic fields coexist, and substances may flow in the conduit and through the area where the synchronized electric and magnetic fields coexist so that pasteurization may occur. In some embodiments, the conduit may extend through two or more treatment regions adjacently located. In some embodiments, the two treatment regions may surround different conduits. In some embodiments, one treatment region may treat substances while the other treatment region may include a dummy load.

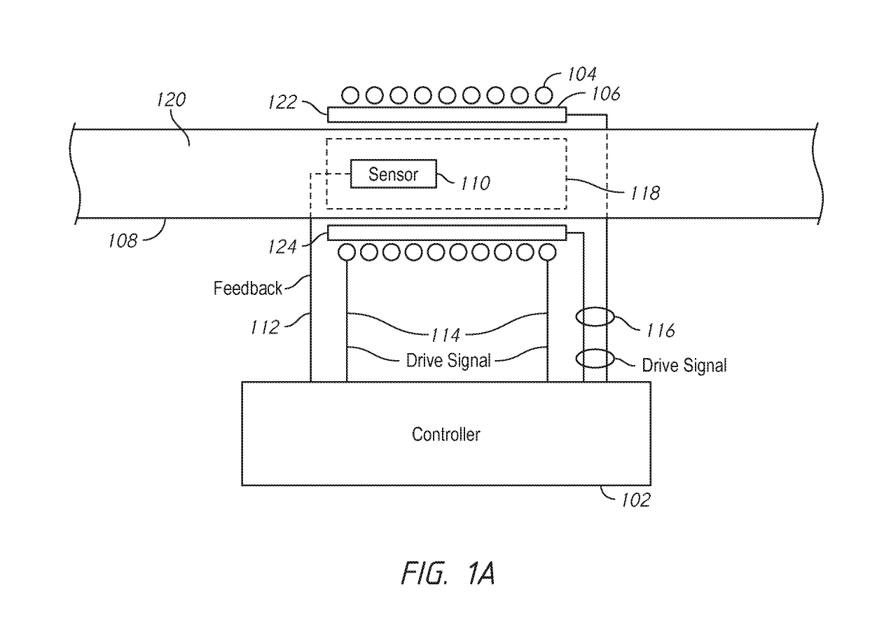

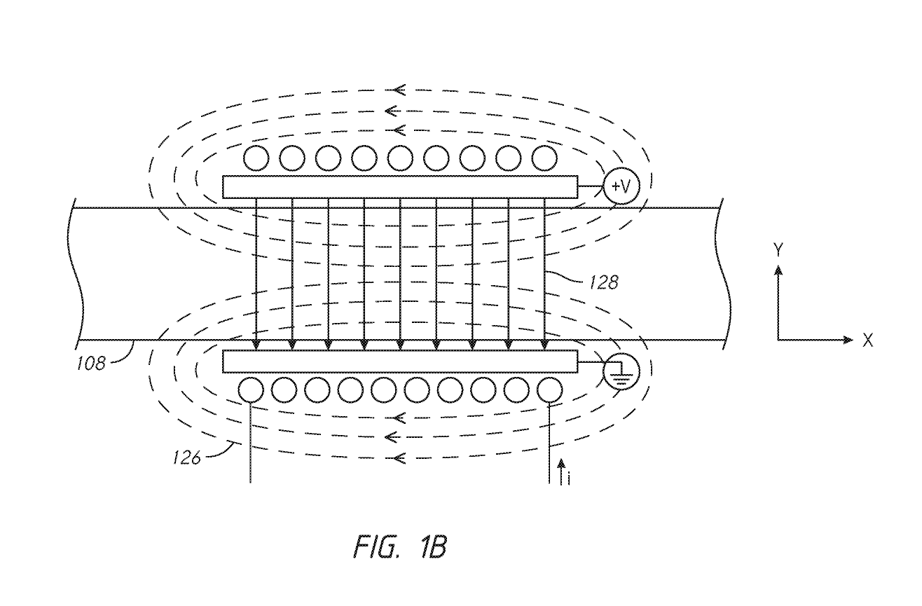

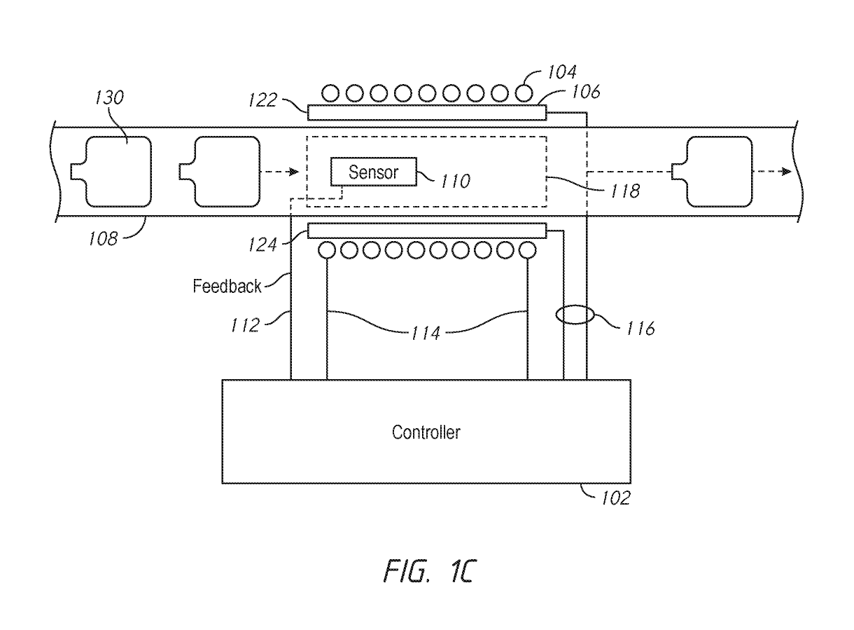

FIG. 1A is a schematic illustration of an example system 100, such as a pasteurization system or a partial pasteurization system for example, arranged in accordance with at least some embodiments described herein. The example system 100 includes a controller 102, an inductive element 104, a capacitance element 106, a conduit 108, and a sensor 110. The example system 100 may be configured to pasteurize substances, such as liquid foods, solid foods, or a combination thereof, by exposing the substances to synchronized electric and magnetic fields, for example. In some examples, the synchronized electric and magnetic fields may be pulsed, e.g., PEF and PMF, so that they are simultaneously present for a desired amount of time. As discussed above, pulsed electric and magnetic fields may allow a substance to be exposed to higher field energies without experiencing breakdown during pasteurization.

The controller 102 is coupled to the inductive element 104 and the capacitive element 106 through couplings 114 and 116, respectively. The controller 102 may be configured to provide electrical signals in the form of voltage and/or current to the inductive element 104 and the capacitive element 106 through couplings 114 and 116, respectively. The controller is further coupled to the sensor 110 through coupling 112. The controller 102 may be configured to receive feedback from the sensor 110 and adjust the electrical signals provided to inductive element 104 and the capacitive element 106 in response thereto.

The inductive element 104 is coupled to the controller 102 through the couplings 114. The inductive element 104 may be formed into a cylindrical shape so that the conduit 108 and the capacitive element 106 may fit within an inner diameter of the inductive element 104. The inductive element 104 may be implemented, for example, using a wire coiled into the cylindrical shape to form a solenoid or an electromagnet, for example. The inductive element 104 may generate a magnetic field when current is provided by the controller 102. The generated magnetic field may at least extend through the inner diameter of the cylindrical shape and in parallel to a central axis of the cylindrical shape of the inductive element 104.

The capacitive element 106 is coupled to the controller 102 through the couplings 116. The capacitive element 106 may be formed, for example, from two conductive plates 122, 124 separated by an air gap, which may form a parallel plate capacitor for example. The air gap separation may be arranged so that the conduit 108 may fit in the air gap that separates the two conductive plates 122, 124. In some embodiments, the capacitive element 106 may be formed on sections of the conduit 108. The capacitive element 106 may be arranged to fit within the inductive element 104. In some embodiments, an electric field generated between the two conductive plates 122, 124 of the capacitive element 104 may extend through the conduit 108. While the capacitive element 106 is depicted as a parallel plate capacitor, the present disclosure is not limited as such and any capacitive element configured to generate an electric field is contemplated by the present disclosure.

The conduit 108 may be configured to provide, e.g., transport, food substances, such as juices, liquid eggs, solid foods, liquid foods with pulp, water, milk, smoothies, liquid cheese, etc. The conduit 108 may be arranged to extend between the two conductive plates 122, 124 of the capacitive element 106 and further extend within an inner diameter of the inductive element 104. The conduit 108 may be formed from any food-grade material known in the art, such as glass, plastic, stainless steel, etc. In some embodiments, the conduit 108 may be formed from multiple materials, such as stainless steel and glass or stainless steel and plastic. For example, arc type cylindrical sections on opposite sides of the conduit 108 may be made of stainless steel, and intervening sections between the stainless steel sections may be formed from glass or plastic. In some embodiments, the stainless steel sections may form the capacitive element 106. The conduit 108 may have any cross-sectional shape that allows for the flow of a food substance, such as round, square, or elliptical to name a few examples.

The sensor 110 may be coupled to the controller 102 through the couplings 112, and may be positioned internal to the conduit 108. The sensor 110 may be configured to detect electric and/or magnetic fields generated by the capacitive element 106 and the inductive element 104, respectively. For example, the sensor 110 may measure an electric field strength is v/cm and/or measure a magnetic field strength in Tesla. The sensor 110 may be a Hall Effect sensor, an inductive sensor, or a combination thereof, for example.

The controller 102 may be configured to provide a drive signal, e.g., a current, to the inductive element 104. The drive signal may cause the inductive element 104 to generate a magnetic field, shown as magnetic force lines 126 of FIG. 1B. The magnetic field may penetrate the conduit 108 and extend along a longitudinal axis of the conduit 108. The length of the conduit 108 that the magnetic field extends may depend on a length of the conduit 108 inside of the inductive element 104. In some embodiments, the controller 102 may provide an oscillation signal as the drive signal to the inductive element 104 in order to generate a pulsed magnetic field. The oscillation signals may be sine waves, square waves, triangular waves, etc. In some embodiments, the drive signals may be pulses ranging from 2 to 200 microseconds in length. The controller 102 may be configured to provide the drive signal with enough energy in order to generate a magnetic field strength on the order of 2 to 100 Tesla.

Further, the controller 102 may be configured to provide a drive signal, e.g., a potential or voltage, to the capacitive element 106. The drive signal may cause a potential difference to be established between the two conductive plates 122, 124. The potential difference may result in the generation of an electric field between the two conductive plates 122, 124, show as electric force lines 128 in FIG. 1B. The electric field may penetrate the conduit 108. In some embodiments, the controller 102 may provide an oscillation signal as the drive signal to the capacitive element 106 in order to generate a pulsed electric field. The oscillation signals may be sine waves, square waves, triangular waves, etc. In some embodiments, the drive signals may be pulses ranging from 1 to 3 microseconds in length. The controller 102 may be configured to provide enough power by the drive signals in order to generate a magnetic field strength on the order of 10 to 30 kV/cm.

FIG. 1B is a schematic illustration of the relation and direction of the magnetic and electric fields the example system 100 generates in accordance with at least some embodiments described herein. FIG. 1B shows only the components of the system 100 needed to illustrate the relation of electric and magnetic fields to the conduit 108, the inductive element 104 and the capacitive element 106.

The inductive element 104, in response to receiving a drive signal from the controller 102 for example, may generate a magnetic field that wraps around the coils of the inductive element 104. Magnetic force lines 126 are shown in FIG. 1B to extend through the inner diameter of the coil and around the outside of the inductive element 104. Further, the magnetic force lines 126 extend substantially parallel to a longitudinal axis of the conduit 108.

The capacitive element 106, in response to receiving a drive signal from the controller 102 for example, may generate an electric field between the two conductive plates 122, 124. For example, an electric field may be generated by providing the conductive plate 106 with a positive potential and providing the conductive plate 124 with a ground potential. As is known, the potential difference between the two conductive plates 122, 124 generates the electric field, and the potential difference may be provided by a single-ended power supply (e.g., providing ground voltage to one plate and a positive or negative voltage to the other plate), or by a dual-ended power supply so that potential placed on the two conductive plates 122, 124 generate an electric field. The electric field is shown as electric force lines 128 in FIG. 1B. The electric force lines 128 extend through the conduit 108 starting from the conductive plate 122 to the conductive plate 124.

In some embodiments, the magnetic field generated by the inductive element 104 in response to the drive signal and the electric filed generated by the capacitive element 106 in response to the drive signal may occur simultaneously. At such a time, the electric and magnetic fields may coexist and their respective force lines may be substantially orthogonal with respect to one another within the conduit 108. For example, the magnetic force lines 126 are orthogonal to the electric force lines 128. The volume of space where the electric and magnetic force lines are substantially orthogonal to one another may be referred to herein as a “treatment region.” Generally, when referred to as orthogonal or substantially orthogonal herein, the relationship is intended to include deviations that may occur when the fields have a complex interaction with the substances (e.g. liquids and/or solids) to be pasteurized, or the containers containing those substances. Generally, the complex interaction with the substances may rotate the electric and/or magnetic fields, and the fields may not be perfectly orthogonal. Generally, however, these rotations may be small, and the physics effects of generally perpendicular electric and magnetic fields may be provided if the fields are not perfectly perpendicular.

Generally, the treatment region may be longer along the magnetic field (and fluid flow) direction than perpendicular to that direction. In some examples large electric field distortions may mainly be in the plane perpendicular to the magnetic field, so the electric field may still be mainly perpendicular to the magnetic field, and the distortions of the magnetic field from induced current may be small.

Orthogonality generally refers to 90 degrees with respect to the field lines between electric and magnetic fields. However, due to various imperfections in the field generation and/or distortion in the fields resulting from conduits, containers, fluids, solids, and other materials, the angles between the orthogonal electric and magnetic fields may vary from 90 degrees by nominal amounts. For example, angles between electric and magnetic fields may be 90 degrees +/−1 degrees, +/−2 degrees, +/−3 degrees, +/−4 degrees, or +/5 degrees. So for example, there may be a 89-91 degree angle between field lines, a 88-92 degree angle, a 87-93 degree angle, a 86-94 degree angle, or a 85-95 degree angle in some examples.

Without being bound by theory, the combination of electric and magnetic pasteurization may have synergistic effects that may increase pathogen kill rate in some examples. One of these effects may be magnetic insulation, which may delay electrical breakdown to higher electric fields. However the magnetic field may not be perfectly perpendicular to the electric field, but instead there may be a small error angle, θ (e.g. θ may be 0 to 5 degrees in some examples). Generally, breakdown voltage may be highest at θ=0 and decrease quadratically (as θ²) with θ. A variation in θ may be tolerated such that breakdown voltage does not change by more than about 10 percent, Which may relate to a variation of up to 5 degrees in some examples. In some examples, measurement of the breakdown voltage may be used to position inductive elements (e.g. magnets) described herein. In some examples, breakdown voltage may be measured as the inductive element (e.g. magnet) may be incrementally moved, and a position of desired and/or maximum breakdown voltage may be selected.

As shown in FIG. 1A, a treatment region 118 may be created in the volume of space the magnetic force lines 126 and the electric force lines 128 extend and coexist. As noted above, substances may be pasteurized when exposed to synchronized magnetic and electric fields. As such, by extending the conduit 108 through the treatment region 118, substances in the conduit 108 passing through the treatment region 118 may be pasteurized due to being exposed to synchronous electric and magnetic fields. In embodiments that generate PEF and PMF, substances in the conduit 108 passing through the treatment region 118 may be pasteurized due to being exposed to synchronous PEF and PMF.

Referring back to FIG. 1A, as a substance 120, such as juice, milk, liquid eggs, smoothie, etc., is being transported, e.g., flowing, through the conduit 108, the system 100 may pasteurize the substance 120 by exposing the substance to synchronous electric and magnetic fields. For example, the controller 102 may provide a drive signal to the inductive element and a drive signal to the capacitive element in order to cause the simultaneous generation of the magnetic field and the electric field. As such, the magnetic and electric fields may be generated synchronously so that the two fields occur in the same volume of space at the same time. The simultaneous exposure of the substance to the magnetic and electric fields may take advantage of the synergistic effect discussed above. The synergistic effect may allow the system 100 to obtain higher kill rates, such as log 4 or log 5, due to the magnetic effect allowing higher electric fields to be applied to the substance without the substance experiencing breakdown.

In sonic embodiments, the controller 102 may provide periodic drive signals to the inductive element 104 and the capacitive element 106. The periodic drive signals may cause the inductive element 104 and the capacitive element 106 to generate pulsed magnetic and electric fields, respectively. As noted above, pulsed fields may allow the system 100 to generate higher electric and magnetic fields further increasing the pasteurization of the substance.

In some embodiments, the system 100 may pasteurize substances, food substances for example, by exposing the substances to synchronous pulsed electric and magnetic fields, e.g., PEF and PMF. The substances may be exposed to the PEF and PMF when in the portion of the conduit 108 extending through the inductive element 104 and the capacitive element 106, e.g., the treatment region 118. The controller 102 may provide drive signals to the inductive element 104 through the couplings 114, and also provide drive signals to the capacitive element 106 through the couplings 116. The drive signals may be periodic signals, e.g., oscillation signals, and may cause the inductive element 104 and the capacitive element 106 to generate magnetic and electric fields, respectively. In some embodiments, the generated magnetic and electric fields may occur at substantially the same time thereby providing electric and magnetic field strengths substantially simultaneously. Substantially simultaneously generally refers to at about the same time. The 100% peak fields may occur at the same time, or a field strength of over 90% of each may occur at the same time in some examples, or a field strength of over 80% of each may occur at the same time in some examples. Generally, field strengths sufficient to cause pasteurization are present together for some length of time. In some examples, the peak field strength of the magnetic and electric fields may be separated by microseconds, milliseconds, or seconds. The sensor 110 may measure the magnetic and/or electric field strengths generated within the treatment region 118. In response, the sensor 110 may provide feedback to the controller 102 based thereon. The controller 102 may adjust the drive signal provided to the inductive element 104, the capacitive element 106, or both based on the feedback to ensure that the magnetic and electric fields meet desired field strengths. Desired field strengths may be dependent upon a substance in the treatment region, but may generally described as strong enough to pasteurize the substance. An example range for target electric field strength may be 10 to 30 kV/cm, and an example range for target magnetic field strength may be 2 to 100 Tesla. In some embodiments, it may be desirable for the electric and magnetic fields to peak substantially simultaneously to obtain the highest kill rate possible. An example range of peak time being 2 to 200 microseconds. While the magnetic and electric fields are being generated, a food substance may be flowing through the conduit 108. When the substance in the conduit 108 is within the treatment region 118, the food substance may be exposed to simultaneous electric and magnetic fields, which may pasteurize the substance.

In some embodiments, the system 100 may be a part of a food processing facility capable of providing desired food substances to the conduit 108 for pasteurization of the food substances. The conduit 108 may be part of a food processing manufacturing line and may receive the food substances from a holding tank, for example, and provide the pasteurized food substances to another holding tank, for example. After pasteurization, the food substances may be provided to a packaging station of the food processing facility.

FIG. 1C is an illustration of an example system 150, a pasteurization or partial pasteurization system, arranged in accordance with at least some embodiments of the present disclosure. The system 150 has many of the same components as the system 100, which are like numbered, and will not be discussed further. The system 150 may be configured to pasteurize packaged food substances. For example, the system 150 may pasteurize packaged substances 130 that may be transported through the treatment region 118 in the conduit 108. The packaging materials may include glass, plastic, paper, and in general be any material susceptible to the penetration of magnetic and electric fields. In some embodiments, a medium may be used to transport the packaged substances 130 through the conduit 108. For example, water may be used to transport the packaged substances 130 through the conduit 108.

The system 150 may cause the inductive element 104 and the capacitive element 106 to generate a magnetic and electric field similar to the system 100. For example, the controller 102 may provide drive signals to the inductive element 104 and the capacitive element 106 through the couplings 114 and 116, respectively. The drive signals, which may be a periodic signal, may cause the inductive element 104 to generate a magnetic field and cause the capacitive element 106 to generate an electric field. The volume of space within the inductive element 104 and the capacitive element 106 where the magnetic and electric fields interact may be the treatment region. As in the system 100, the conduit 108 extends through the treatment region 118 thereby transporting the packaged substances 130 through the treatment region 118. While the packaged substances are in the treatment region 118 they may be exposed to magnetic and electric fields at field strengths strong enough to pasteurize the packaged substances 130. In some embodiments, the controller 102 may provide pulsed drive signals that cause the inductive element 104 and the capacitive element 106 to generate pulsed magnetic and electric fields.

In some examples, the food substance, including packages of food in some examples, in the conduit 108 may continuously flow through the treatment region 118 as it is being pasteurized (e.g. the food substance and/or packages of food substances may be moving in the conduit 108 through the treatment region 118 as electric and/or magnetic fields are being applied across the conduit 118). While the conduit 108 may naturally lend itself to pasteurization systems that treat a continuous flow of fluid, such an example is non-limiting and pasteurization systems that treat a series of set volumes in batch presses are also covered by the present disclosure. For example, the fluid and/or packages of fluid may be stationary in the conduit 108 during the duration, or a portion of the duration, of electric and/or magnetic fields applied through and across the conduit 108. For example, a batch process may be used where a length of the conduit 108 may be filled with a liquid, including a package of liquid in some examples, and electric and/or magnetic fields may be applied to the liquid, and then the pasteurized liquid may be removed from the conduit 108. The conduit 108 may generally be formed from any food grade material that allows for electric and magnetic fields to be applied across the conduit 108. Food substances in the conduit 108 may be exposed to, e.g. treated by, electric and/or magnetic fields applied through and across the conduit 108.

The pasteurization system 100 may serve to pasteurize liquids provided in the conduit 110 either continuously or in batches. Liquids which may be pasteurized in accordance with examples described herein include, but are not limited to, alcoholic beverages including wine and beer, water, milk, juice (including vegetable and fruit juices), syrup, vinegar, and combinations thereof. In some examples, solid food products may be transported through conduit 110 and may be pasteurized in accordance with examples described herein. Such solid food products include, but are not limited to, dairy products including cheese and butter, and eggs.

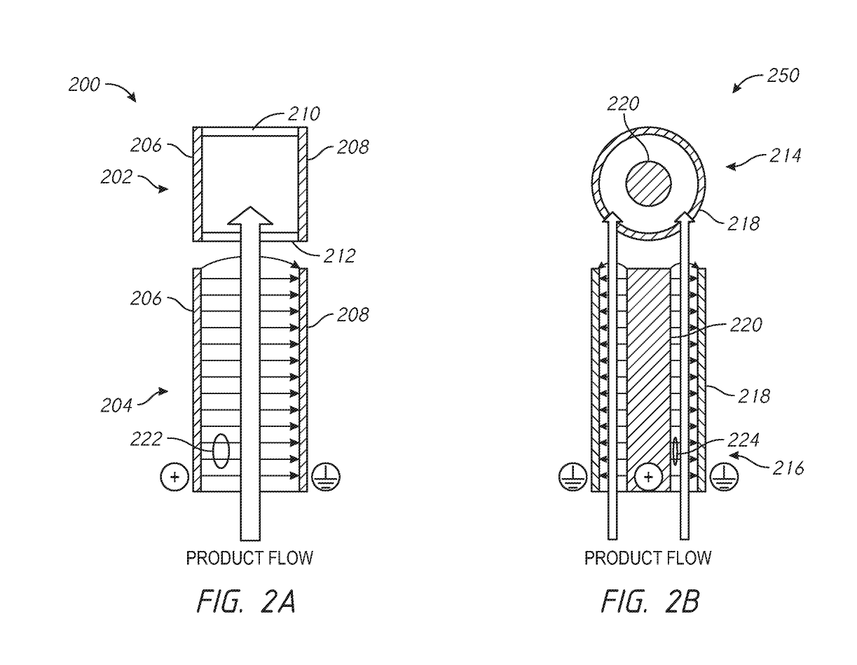

FIGS. 2A and 2B are schematic illustrations of arrangements for capacitive elements, arranged in accordance with at least some embodiments described herein. FIG. 2A shows two cross-sectional views of a capacitive element 200, which may be used to implement the capacitive element 106 of FIG. 1A. FIG. 2B shows two cross-sectional views of a capacitive element 250 which may be used to implement the capacitive element 106 of FIG. 1A. In some embodiments, the capacitive elements 200 and 250 may also form at least a portion of the conduit 108 of FIG. 1A. Stated another way, at least a portion of the conduit 108 may be configured to form a capacitive element, such as the capacitive element 200 and 250. The various components described in FIGS. 2A and 2B are merely examples, and other variations, including eliminating components, combining components, and substituting components are all contemplated.

The top portion of FIG. 2A shows an axial cross-sectional view 202 of the capacitive element 200. The capacitive element 200 includes two conductive sides 206 and 208, and two insulator sides 210 and 212. The two conductive sides 206 and 208 are separated from each other by the two insulator sides 210 and 212 so that the two conductive sides 206 and 208 form a parallel plate capacitor around an air gap. The air gap may establish a capacitive effect between the two conductive sides 206 and 208. The two conductive sides 206 and 208 may be formed from any conductive material, stainless steel for example, and the two insulator sides may be formed from any non-conductive material, glass or plastic for example.

The bottom portion of FIG. 2A shows a longitudinal cross-sectional view 204 of the capacitive element 200. As shown in the view 204, the two conductive sides 206 and 208 form a parallel plate capacitor that operationally generates an electric field extending between the two plates of the capacitor when a potential difference is established between the two conductive plates. The electric field is shown by the force lines 222. For example, a positive voltage may be applied to one side of the region 200, the left for example, and the opposing side, the right for example, may be grounded. However, the present disclosure contemplates any known technique to establish the potential difference between the two conductive sides 206 and 208. For example, the potential difference may be established as shown using a single-ended power supply. In some embodiments, a potential difference may be established using a differential power supply, which may provide a positive voltage to one of the two conductive sides 206, 208 and a negative voltage to the other conductive side 208, 206. In some embodiments, the potential difference may be established by a controller providing a drive signal, such as the controller 102 of FIG. 1A for example.

The top portion of FIG. 2B is a cross-sectional view 214 of a capacitive element 250. The capacitive element 250 may include a core 220 and a cylindrical outer shell 218. The arrangement of the core 220 and the cylindrical outer shell 218 may form a coaxial capacitor. The core 220 may be separated from the cylindrical outer shell 218 by an air gap, and may be attached to the cylindrical outer shell at periodic locations by an insulator material so that the core 220 extends along a longitudinal axis of the cylindrical outer shell 218. The air gap between the core 220 and the cylindrical outer shell 218 may establish a capacitive effect between the two components. The core 220 and the cylindrical shell 218 may be implemented using one or more conductive materials, stainless steel for example. In some embodiments, the capacitive element 250 may form at least a portion of a conduit, such as the conduit 108 of FIG. 1A. In some examples, a substance may flow though the capacitive element 50 in the gap between the core and the cylindrical outer shell 218.

The bottom portion of FIG. 2B shows a longitudinal cross-sectional view 216 of the capacitive element 250. To generate an electric field in the capacitive element 250, a potential difference may be established between the core 220 and cylindrical outer shell 218. For example, the core 220 may be provided a positive voltage while the cylindrical outer shell 218 may be grounded. As such, a potential difference may be established between the core 220 and the cylindrical outer shell 218, which may generate a radial electric field between them. A radial electric field is shown as force lines 224 originating on the core 220 and ending on the cylindrical outer shell 218. However, the present disclosure contemplates any known technique to establish the potential difference between the core 220 and cylindrical outer shell 218. For example, the potential difference may be established as shown using a single-ended power supply. In some embodiments, a potential difference may be established using a differential power supply, which may provide a positive voltage to one of either the core 220 or cylindrical outer shell 218 and a negative voltage to the other. In some embodiments, the potential difference may be established by a controller providing a drive signal, such as the controller 102 of FIG. 1A for example.

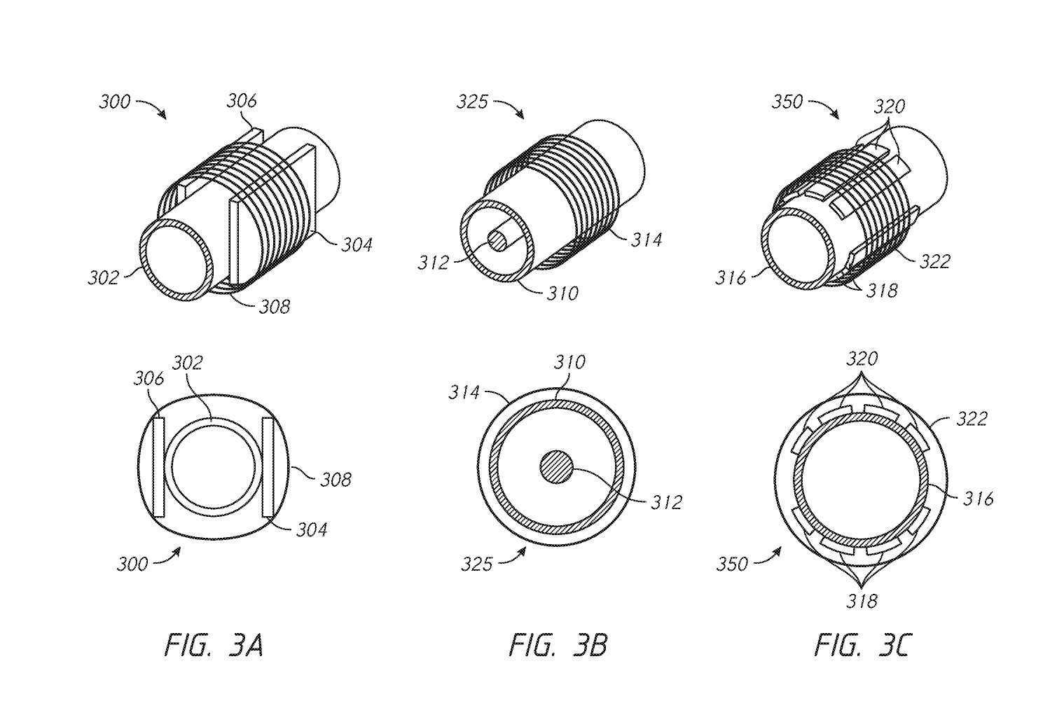

FIGS. 3A through 3C are schematic illustrations of various example configurations for conduits, capacitive elements and inductive elements in accordance with at least some embodiments of the present disclosure. FIG. 3A is a schematic illustration of an example configuration 300 in accordance with at least some embodiments of the present disclosure. The example configuration 300 includes a conduit 302, a capacitive element 304, and an inductive element 308. The example configuration 300 may be used in either the system 100 or 150, for example, as a configuration to arrange the capacitive element 106, the inductive element 104, and the conduit 108. The bottom portion of FIG. 3A shows a cross-sectional view of the example configuration 300. For the example configuration 300, the capacitive element 304 is depicted as being formed from two plates located on opposite sides of the conduit 302. As such, the capacitive element 304 may form a parallel plate capacitor with the gap between the two sides establishing the capacitive effect for the capacitive element 304. Additionally, the two plates may have a height commensurate with a diameter of the conduit 302 so that when energized, the capacitive element 304 may generate an electric field that extends across all internal volume of the conduit 302. The inductive element 306 is shown as a circle encompassing the conduit 302 and the capacitive element 304.

The top portion of FIG. 3A shows a perspective view of the example configuration 300. As can be seen in the top portion of FIG. 3A, the capacitive element 304 may have a length that extends along at least a portion of the conduit 302. Additionally, the inductive element 306 may be formed from a coiled wire having a cylindrical shape with a diameter and a length. The diameter of the inductive element 306 may be large enough to encompass the conduit 302 and the capacitive element 304, and the length of the inductive element 306 may be commensurate with a length of the capacitive element 304. When energized, the inductive element 308 may generate a magnetic field that extends into the conduit 302 and extends along a longitudinal axis of the conduit 302. The volume of space within both the capacitive element 304 and the inductive element 306 may form a treatment region, such as the treatment region 118 of FIG. 1A, since that volume is where generated magnetic and electric fields may coexist and interact as discussed above with regards to FIG. 1B. Accordingly, the portion of the conduit 302 extending through the treatment region may be able to deliver substances through the treatment region for purposes of pasteurization.

FIG. 3B is a schematic illustration of an example configuration 325 in accordance with at least some embodiments of the present disclosure. The example configuration 325 includes a cylindrical outer shell 310, a core 312, and an inductive element 314. The cylindrical outer shell 310 and the core 312 may be separated by an air gap and may in combination form a capacitive element. The example configuration 325 may be used in either the system 100 or 150, for example, as a configuration to arrange the capacitive element 106, the inductive element 104, and the conduit 108. The bottom portion of FIG. 3B shows a cross-sectional view of the example configuration 325. For the example configuration 325, the capacitive element is formed from the core 312 and the cylindrical outer shell 310. As such, the capacitive element may be a coaxial capacitor with the gap between the core and the cylindrical outer shell establishing the capacitive effect. Additionally, the cylindrical outer shell 310 may form at least a portion of a conduit, such as the conduit 108 of FIG. 1A. When energized, the coaxial capacitive element may generate an electric field that extends across a volume of conduit between the core 312 and the cylindrical outer shell 310. The inductive element 314 is shown as a circle encompassing the cylindrical outer shell 310.

The top portion of FIG. 3B shows a perspective view of the example configuration 325. As can be seen in the top portion of FIG. 3B, the core 312 may have a length that extends along at least a portion of the cylindrical outer shell 310. The cylindrical outer shell 310 and the core 312 may be conductive for a commensurate length. The commensurate length the cylindrical outer shell 310 and the core 312 are both conductive may establish the coaxial capacitive element. Additionally, the inductive element 314 may be formed from a coiled wire having a cylindrical shape with a diameter and a length. The diameter of the inductive element 314 may be large enough to encompass the cylindrical outer shell 310, and the length of the inductive element 314 may be commensurate at least with the established coaxial capacitive element. When energized, the inductive element 314 may generate a magnetic field that extends into the cylindrical outer shell 310 and extends along the core 312. As such, the magnetic field may be present in the gap between the core 312 and the cylindrical outer shell 310. The volume of space within both the established coaxial capacitive element and the inductive element 314 may form a treatment region, such as the treatment region 118 of FIG. 1A, since that volume is where generated magnetic and electric fields may coexist and interact as discussed above with regards to FIG. 1B.

FIG. 3C is a schematic illustration of an example configuration 350 in accordance with at least some embodiments of the present disclosure. The example configuration 350 includes a conduit 316, a plurality of arc type conductive portions 318 and 320, and an inductive element 322. The example configuration 350 may be used in either the system 100 or 150, for example, as a configuration to arrange the capacitive element 106, the inductive element 104, and the conduit 108. The bottom portion of FIG. 3A shows a cross-sectional view of the example configuration 350. In some embodiments, the plurality of arc type conductive elements 318 and 320 may be formed on an outer surface of the conduit 316. In sonic embodiments, the plurality of conductive elements 318 and 320 may form arc type portions of the conduit 316. For the example configuration 350, a capacitive element may be formed from the plurality of arc type conductive portions 318 and the plurality of arc type conductive portions 320. For example, the plurality of arc type conductive portions 318 may form one side of a capacitive element, while the plurality of arc type conductive portions 320 form another side of a capacitive element. The conduit 316 may form an air gap between the two sides of the formed capacitive element. As such, the capacitive element formed from the plurality of conductive elements 318 and 320 may approximate a parallel plate capacitor having an air gap commensurate with a diameter of the conduit 316. To generate an electric field within the conduit 316, the plurality of arc type conductive elements 318 and 320 may be provided with a plurality of different potentials. These potentials may be adjusted for example, to provide an electric field of constant strength and direction in the treatment zone similar to that provided by two parallel plates in FIG. 3A. Generally, various different voltages may be applied to segments of the elements 318 and 320 to allow for the shaping of fields. The inductive element 322 is shown as a circle encompassing the conduit 316 and the plurality of conductive elements 318 and 322.

The top portion of FIG. 3C shows a perspective view of the example configuration 350. As can be seen in the top portion of FIG. 3C, the plurality of arc type conductive elements 318 and 320 may have a length that extends along at least a portion of the conduit 316. Additionally, the inductive element 322 may be formed from a coiled wire having a cylindrical shape with a diameter and a length. The diameter of the inductive element 322 may be large enough to encompass the conduit 316 and the plurality of arc type conductive elements 318 and 320, and the length of the inductive element 306 may be commensurate with a length of the plurality of arc type conductive elements 318 and 320. When energized, the inductive element 320 may generate a magnetic field that extends into the conduit 316 and along a longitudinal axis of the conduit 316. The volume of space within both the plurality of conductive elements 318 and 320 and the inductive element 306 may form a treatment region, such as the treatment region 118 of FIG. 1A, since that volume is where generated magnetic and electric fields may coexist and interact as discussed above with regards to FIG. 1B. Accordingly, the portion of the conduit 316 extending through the treatment region may be able to deliver substances through the treatment region for purposes of pasteurization.

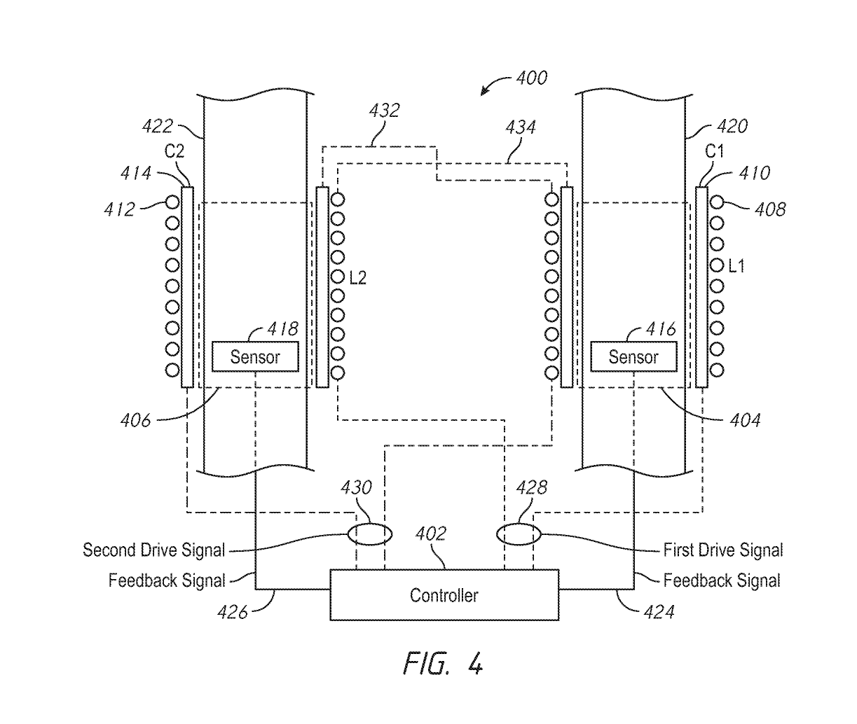

FIG. 4 is a schematic illustration of a pasteurization system 400 arranged in accordance with at least some embodiments described herein. FIG. 4 includes a controller 402, a first inductance 408, a first capacitance 410, a second inductance 412, a second capacitance 414, a first sensor 416, a second sensor 418, a first conduit 420, and a second conduit 422. The system 400 may include two example systems 100 or 150 having their electrical components, e.g., inductive and capacitive elements cross-coupled. The various components described in FIG. 4 are merely examples, and other variations, including eliminating components, combining components, and substituting components are all contemplated.

The controller 402 may be coupled to the first inductance 408 and the second capacitance through couplings 430. Additionally, the controller 402 may be coupled to the second conductance 412 and the first capacitance 410 through the couplings 428. The controller may further be coupled to the first sensor 416 through coupling 424, and also coupled to the second sensor 418 through coupling 426.

The first inductance 408 may be coupled to the controller 402, and further coupled to the second capacitance 414 through coupling 432. The first inductance 408 may be physically arranged around both the first capacitance 410 and the first conduit 420. The first capacitance is coupled to the controller 402, and further coupled to the second inductance 412 through coupling 434. The first capacitance is physically arranged about the first conduit 420.

The second conductance is coupled to the controller 402, and further coupled to the first capacitance 410 through the coupling 434. The second inductance is physically arranged around both the second capacitance 414 and second conduit 422. The second capacitance is coupled to the controller 402, and further coupled to the first inductance 408 through the coupling 432.

The first sensor 416 is arranged within the first conduit 420 and coupled to the controller 402. The second sensor 418 is arranged within the second conduit 422 and coupled to the controller 402.

A first conduit 420 may extend through the first inductance 408 and between the first capacitance 410. The first conduit 420 may be of any cross-sectional shape, such as round, square, elliptical, etc., and the first conduit 420 may be configured to transport food substances, such as liquid foods, solid foods, or combinations thereof, through a pasteurization treatment region. The second conduit 422 may extend through the second inductance 412, and between the second capacitance 414. The second conduit 422 may be of any cross-sectional shape, such as round, square, elliptical, etc., and the second conduit 422 may be configured to transport food substances, such as liquid foods, solid foods, or combinations thereof, through a pasteurization treatment region.

A first resonant circuit may be formed by the first inductance 410 and the second capacitance 414. The controller 402 may provide first drive signals to the first resonant circuit through couplings 428. Further, a second resonant circuit may be formed by the second inductance 412 and the first capacitance 410. The controller 402 may provide second drive signals to the second resonant circuit through couplings 430.

A first treatment region 404 may be formed from the physical arrangement of the first inductance 408 and the first capacitance 410. The first treatment region 404 may be a volume where a magnetic field generated by the first inductance 408 and an electric field of the first capacitance 410 may coexist, e.g., occupy. The magnetic field generated by the first inductance 408 and the electric field generated by the first capacitance 410 may be substantially orthogonal to one another within the treatment region, and may appear similar to the electric and magnetic fields shown in FIG. 1B. The physical arrangement of the first inductance 408, the first capacitance 410, and the first conduit 420 may be configured as any of the examples shown in FIGS. 3A through 3C.

A second treatment region 406 may be formed from the physical arrangement of the second inductance 412 and the second capacitance 414. The second treatment region 406 may be a volume where a magnetic field generated by the second inductance 412 and an electric field generated by the second capacitance 414 may coexist, e.g., occupy. The first and second treatment regions 404 and 406 may be similar to the treatment region 118 of FIG. 1A, for example. The magnetic field generated by the second inductance 412 and the electric field generated by the second capacitance 414 may be substantially orthogonal to one another within the treatment region, and may appear similar to the electric and magnetic fields shown in FIG. 1B. Similarly, the physical arrangement of the second inductance 412, the second capacitance 414, and the second conduit 422 may be configured as any of the examples shown in FIGS. 3A through 3C.

As discussed herein, it may be desirable to operate pulsed electric and/or pulsed magnetic field pasteurization systems utilizing two or more resonant circuits. Having two or more resonant circuits may provide some energy saving due to energy within the circuit oscillating between inductive and capacitive elements. However, generally in a single resonant circuit being energized with a periodic signal, the energy in the capacitive element may generate an electric field at a first time that then the energy in the capacitive element may begin to move to the inductive element based on changes in the periodic signal. In response, the energy in the inductive element may begin to generate a magnetic field at a second time that follows in sequence. Using a single resonant circuit for a treatment region may make it difficult to provide synchronized magnetic and electric fields in some examples. Some examples described herein, such as the pasteurization system 400 shown in FIG. 4, include multiple treatment regions. The multiple treatment regions, e.g., 404 and 406, may be characterized as being cross-coupled such that an inductive element physically associated with one treatment region is electrically coupled to a capacitive element physically associated with another treatment region to form a resonant circuit. By electrically coupling the inductive and capacitive elements of two treatment regions, for example, in such a manner, the two resonant circuits may be driven simultaneously to cause the magnetic field generated in one resonant circuit to occur in time with the magnetic field generated in the other resonant circuit. Further, because the capacitance element of one resonant circuit is physically associated with the inductive element of the other resonant circuit, the electric and magnetic fields may occur simultaneously within the same treatment region. Additionally, since energy may flow between the capacitive and inductive elements of each resonant circuit, as is known in the art, the two treatment regions may be said to be energized at different times. When periodic signals are used to energize the resonant circuits, the energy may appear to oscillate between the two treatment regions.

The treatment regions 404, 406 may each be implemented using, for example, at least park of the system 100 of FIG. 1A. Each the treatment region 404, 406 may have at least one associated inductive element and one associated capacitive element. The capacitive elements may be implemented using, for example, parallel plates used to form a parallel plate treatment region and/or conductive tubes and cores used to bring substances to be pasteurized through a coaxial treatment region in some examples. The inductive elements may be implemented using conductive coils and/or magnets positioned to provide a magnetic field extending through the respective conduit and along a longitudinal axis of the conduit. As shown, the first treatment region 404 is formed by the first capacitive element 410, implemented as parallel conductive plates for example, and the first inductive element 408, implemented as a magnet coiled around the conduit 220 for example. As shown, the second treatment region 406 is formed by the second capacitive element 414, implemented as parallel conductive plates for example, and the second inductive element 412, implemented as a magnet coiled around the conduit 222 for example. Additional capacitive elements and/or inductive elements may be associated with the treatment regions shown in FIG. 4, for example, to tune resonant circuits including the capacitive and/or inductive elements or to store excessive energy. For example, the energy to generate the desired magnetic field strength may be more than the energy needed to generate the desired electric field strength. As such, extra capacitors not physically associated with either treatment region may be included in the first and second resonant circuits to store the excess energy.

Generally, the capacitive and inductive elements shown in FIG. 4 may be arranged to generate an electric field and a magnetic field, respectively, extending through and along the conduit which with they are associated. Generally, in examples described herein, the capacitive and inductive elements may be positioned to generate magnetic fields in a substantially orthogonal direction with respect to the electric fields (not including disruptions in the fields due to items in the treatment region). For example, the capacitive elements 410 and 414 are arranged to generate an electric field extending across the conduits 420 and 422, while the inductive elements 408 and 412 are arranged to generate a magnetic field extending along a longitudinal axis of the conduits 420 and 422. In this manner, substantially orthogonal electric and magnetic fields may be provided in the conduits 420 and 422.

In examples described herein, multiple treatment regions may be cross-coupled such that multiple resonant circuits are formed. Examples may allow for synchronized peak electric and magnetic fields to be provided in treatment regions utilizing the multiple resonant circuits. While two treatment regions and two resonant circuits are described with reference to FIG. 4, other numbers of treatment regions and resonant circuits may be used in other examples, including three, four, five, six, seven, eight, nine, ten, or other numbers of treatment regions and resonant circuits. The first inductive element 408 (positioned to provide a magnetic field in the first treatment region 404) may be electrically coupled to the second capacitive element 414 (positioned to provide an electric field in the second treatment region 406). Accordingly, the first inductive element 408 and the second capacitive element 414 may form a first resonant circuit. Additional capacitive, inductive, and/or resistive elements may also be included in that resonant circuit in some examples. The resonant circuit including the inductive element 408 and the capacitive element 414 may be driven by the controller 402. Based on the fundamental operation of a resonant circuit, the drive signal provided by the controller 402 may first cause the capacitive element 414 to generate an electric field in the treatment region 406, and then cause the inductive element 408 to generate a magnetic field in the treatment region 404. Similarly, the inductive element 412 (positioned to provide a magnetic field in the treatment region 406) and the capacitive element 410 (positioned to provide an electric field in the treatment region 404) may be coupled to form the second resonant circuit. The controller 402 (or another controller in some examples) may drive the second resonant circuit such that the drive signal provided by the controller 402 may first cause the capacitive element 410 to generate an electric field in the treatment region 404, and then cause the inductive element 412 to generate a magnetic field in the treatment region 406.

The controller 402 may provide out of phase (e.g. 90 degree out of phase) signals to the two resonant circuits such that a peak magnetic field occurs in the region 406 using the inductive element 412 of one resonant circuit while a peak electric field also occurs at substantially a same time in the region 406 using the capacitive element 414 of the other resonant circuit. Further, at a different time, a peak magnetic field may occur in the region 406 using the inductive element 412 of one resonant circuit while a peak electric field also occurs at substantially a same time in the region 406 using the capacitive element 414 of the other resonant circuit. Accordingly, because the two resonant circuits are arranged such that the capacitance of one is physically associated with the inductance of the other, the inductance and the capacitance of one treatment region may simultaneously be providing their respective fields. While a 90 degree phase difference between the signals provided to the resonant circuits has been described, other phase differences may be used, including between 85 and 95 degrees in some examples, between 75 and 105 degrees in some examples, or other phase differences in other examples. Moreover, in examples with a different number of treatment regions and resonant circuits, a phase difference between signals provided to the resonant circuits may be selected to achieve peak magnetic and electric fields within a same region.

The sensors 418, 416 may be configured to measure electric and/or magnetic field strengths of their respective treatment regions and provide the measurements to the controller 402. The sensors 416, 418 may be at least arranged so that they measure both the fields generated by the respective capacitive and inductive elements, and the location of the sensors shown in FIG. 4 should be not limiting. The controller 402 may adjust the drive signals provided to the resonant circuits described herein to achieve and/or maintain desired peak electric and magnetic field strengths occurring at substantially the same time in a given treatment region.

The controller 402 may be configured to provide the drive signals (e.g. voltage, current) to the resonant circuits of the system shown in FIG. 4. The controller 402 may accordingly be coupled to a voltage, current, and/or other power source that is configured to selectively supply power to the resonant circuits. In some examples, the controller 402 may be configured to provide a first resonant circuit (e.g. including the inductive element 408 and the capacitive element 414) a first drive signal, and further provide a second resonant circuit (e.g. including the capacitive element 410 and the inductive element 412) a second drive signal. The first and second drive signals may be substantially similar based on the first and second resonant circuits being substantially similar, but may be provided at different times. For example, the first and second signals may be oscillating signals, such as sine waves, square waves, DC pulses, etc., that may be provided out of phase with respect to one another but otherwise matched in terms of amplitude, frequency, duty-cycle, etc.

The controller 402 may be configured to provide signals to the resonant circuits at their resonant frequency to obtain improved and/or maximum energy efficiency from each. In some examples, the controller 402 may dynamically adjust the signals provided to the resonant circuits based on feedback received from the sensors 416 and 418. For example, controller 402 may be configured to adjust the amplitude, and/or frequency, phase, duty-cycle, period or other characteristics of the first or second signals provided to the first and second resonant circuits based on the timing of the peak electric and magnetic fields in one or more of the treatment regions.

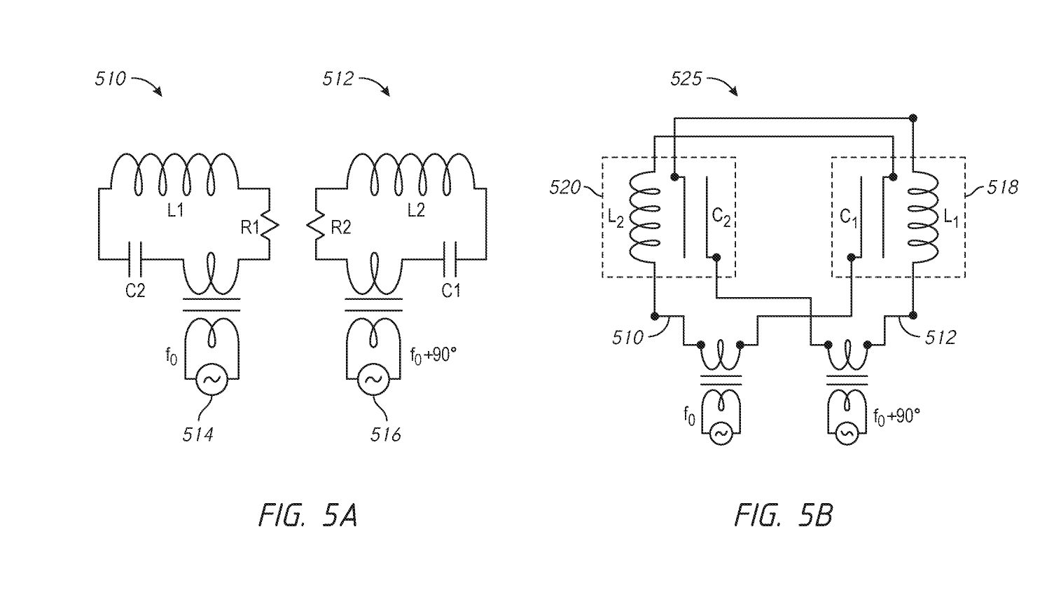

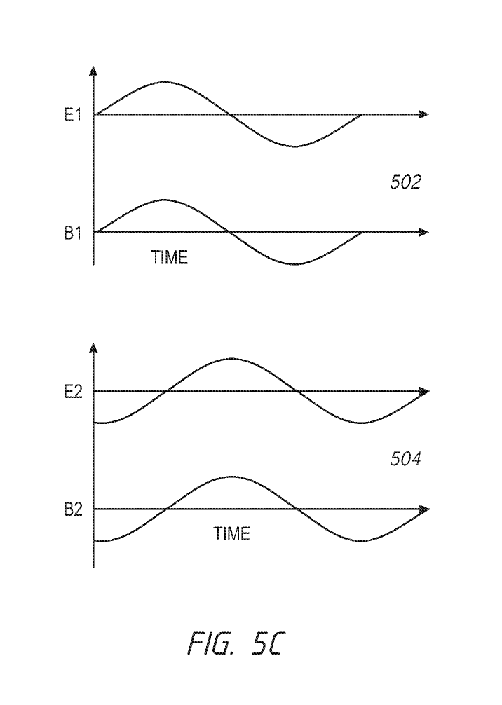

FIG. 5A is a schematic illustration of portions of the pasteurization system 400 of FIG. 4 arranged in accordance with some embodiments described herein.

FIG. 5A shows first and second resonant circuits 510 and 512. The first resonant circuit 510 includes first inductor L1 (which may include the inductive element 408 of FIG. 4), resistance R1 (which may include parasitic resistances associated with the inductive element 408 and capacitive element 414 of FIG. 4), and second capacitor C2 (which may include the capacitive element 414 of FIG. 4). A signal source 514 is shown inductively coupled to the first resonant circuit 510. The signal source 514 may be controlled, for example by the controller 402 of FIG. 4 and/or the controller 402 of FIG. 4 may be programmed or otherwise arranged to provide the varying signals described herein. The second resonant circuit 512 includes second inductor L2 (which may include the inductive element 412 of FIG. 4), resistor R2 (which may include the parasitic resistances of inductive element 412 of FIG. 4 and capacitive element 410 of FIG. 4), and first capacitor C1 (which may include the capacitive element 410 of FIG. 4). The second resonant circuit 512 is shown inductively coupled to signal source 516. The signal source 516 may be controlled, for example by the controller 402 of FIG. 4 and/or the controller 402 of FIG. 4 may be programmed or otherwise arranged to provide the varying signals described herein. The signal sources 514 and 516 may be implemented, for example, by voltage or current sources.

The signal sources 514 and 516 may configured to provide oscillation signals at a resonant frequency f₀ of their respective resonant circuits. For purposes of illustration, the oscillating signals may be sine waves of a desired frequency, based on resonant frequency f₀, and a desired amplitude. Additionally, the signal sources 514, 516 may be providing oscillating signals which are substantially 90-degrees out of phase with one another. The use of 90-degrees is for illustrative purposes only and should not be considered limiting. In some embodiments, the resonant frequencies of the first and second resonant circuits 514, 516 may be substantially the same, however different resonant frequencies may also be used.

In some embodiments, the first and second resonant circuits 510, 512 may be designed based on a desired frequency at which the electric and magnetic fields are to be pulsed. Based on the desired frequency, the resonant frequency f₀ of each resonant circuit (e.g. the value of the inductive, resistive, and capacitive elements in the circuit) may be selected to match the desired frequency for the pulsed electric and magnetic fields.

FIG. 5B is an example physical arrangement 525 of the two resonant circuits 510. 512 in accordance with at least some embodiments discussed herein. The first and second resonant circuits 510 and 512 may be electrically coupled as shown in FIG. 5A, but may be physically arranged as shown in FIG. 5B. The physical arrangement of the two cross-coupled resonant circuits 525 shows that the first inductor L1 is physically arranged in close proximity to the second capacitor C2, which may be associated with a treatment region 518 for example. The treatment region 518 may be an example of the treatment region 404 of FIG. 4. Similarly, the physical arrangement of the second inductor L2 and the first capacitor C1 may be associated with a treatment region 520. The treatment region 520 may be an example of the treatment region 406 of FIG. 4. While FIG. 5A shows the electrical couplings of the two cross-coupled resonant circuits, FIG. 5B may provide the physical arrangement of the two cross-coupled resonant circuits. Although the two resonant circuits are discussed as being cross-coupled, the cross-coupling aspect of the present disclosure characterizes the treatment regions formed by the two resonant circuits 510, 512.

FIG. 5C is a timing diagram showing electric and magnetic field amplitudes in the treatment regions 404 and 406 over time in accordance with some examples described herein. The top graph 502 illustrates an example electric field E1 and an example magnetic field B1 which may be provided in the treatment region 518. The lower graph 504 illustrates an example electric field E2 and an example magnetic field B2 which may be provided in the treatment region 520. The electric field E1 may be generated by the operation of capacitor C1 (e.g. the capacitive element 410 of FIG. 4) and the magnetic field B1 may be generated by the operation of inductor L1 (e.g. the inductive element 408 of FIG. 4). Because C1 and L1 are portions of different resonant circuits, and the two resonant circuits are driven 90-degrees out of phase, fields E1 and B1 may be synchronized and simultaneously occur within the treatment region 518. The bottom graph shows the electric field E2 generated by the operation of capacitor C2 (e.g. the capacitive element 414 of FIG. 4) and the magnetic field B2 generated by the operation of inductor L2 (e.g. the inductive element 412 of FIG. 4). Because C2 and L2 are part of different resonant circuits, and the two resonant circuits are driven 90-degrees out of phase, E2 and B2 may be synchronized and simultaneously occur within the treatment region 520.

In some embodiments, a desired magnetic field amplitude may be around 2 Tesla and a desired electric field amplitude may be around 10 kV/cm, although other strengths may be used in other examples. A 10 KV/cm electric field magnitude, however, may be generated by a much lower power than a 2 magnetic field magnitude. As such, the energy density of the magnetic field may be larger than the energy density of the electric field. As such, extra capacitance may be added to each resonant circuit to store the extra energy received from the inductive element. In some embodiments, the extra capacitance may be coupled in parallel with the capacitive element used to provide the electric field in the treatment region (e.g. the capacitive elements 410 and 414 of FIG. 4).

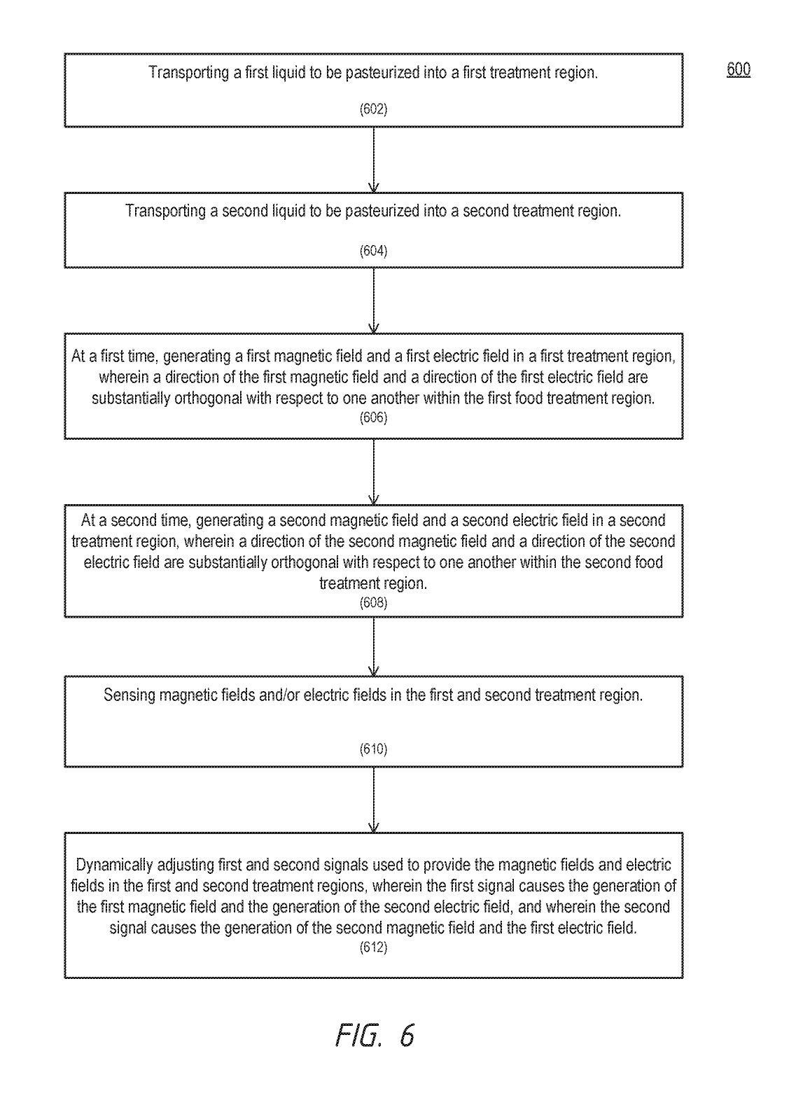

FIG. 6 is a flow chart illustrating an example method 600 for pasteurization in accordance with at least some embodiments described herein. An example method may include one or more operations, functions or actions as illustrated by one or more of blocks 602 and/or 604. The operations described in the blocks 602 through 610 may be performed in response to execution (such as by one or more processors described herein) of computer-executable instructions stored in a computer-readable medium, such as a computer-readable medium of a computing device or some other controller similarly configured.

An example process may begin with block 602, which recites “providing a first substance to be pasteurized into a first treatment region.” Block 602 may be followed by block 604 which recites “providing a second substance to be pasteurized into a second treatment region.” Block 604 may be followed by block 606 which recites “at a first time, generating a first magnetic field and a first electric field in the first treatment region, wherein a direction of the first magnetic field and a direction the first electric field are substantially orthogonal with respect to one another within the first treatment region.” Block 606 may be followed by block 608, which recites “at a second time, generating a second magnetic field and a second electric field in the second treatment region, wherein a direction of the second magnetic field and a direction of the second electric field are substantially orthogonal with respect to one another within the second treatment region.” Block 608 may be followed by block 610, which recites “sensing magnetic fields and/or electric fields in the first and second treatment regions.” Block 610 may be followed by block 612, which recites “dynamically adjusting first and second signals used to provide the magnetic fields and electric fields in the first and second treatment regions, wherein the first signal causes the generation of the first magnetic field and the generation of the second electric field, and wherein the second signal causes the generation of the second magnetic field and the first electric field.”

The blocks included in the described example methods are for illustration purposes. In some embodiments, the blocks may be performed in a different order. In some other embodiments, various blocks may be eliminated. In still other embodiments, various blocks may be divided into additional blocks, supplemented with other blocks, or combined together into fewer blocks. Other variations of these specific blocks are contemplated, including changes in the order of the blocks, changes in the content of the blocks being split or combined into other blocks, etc. In some examples, simultaneously providing a peak first magnetic field and a peak first electric field in a first treatment region and simultaneously, at a second time, providing a peak second magnetic field and a peak second electric field in a second treatment region may be performed at different times, e.g., the first time and the second time being different.

Block 602 recites “transporting a first substance to be pasteurized into a first treatment region.” Block 602 may be followed by block 604 which recites “transporting a second substance to be pasteurized into a second treatment region.” In some examples, the substances may be portions of a same liquid food (e.g. milk, water, alcoholic beverage, juice, vinegar). In some examples, the substances in the first and second treatment regions may be different. The transportation may occur through any mechanism for fluid motion, including continuous pumping or batch processing, e.g. loading a conduit or other vessel containing the treatment region with the fluid.

Block 606 recites, “at a first time, generating a first magnetic field and a first electric field in the first treatment region, wherein a direction of the first magnetic field and a direction of the first electric field are substantially orthogonal with respect to one another within the first food treatment region.” Block 608 recites “at a second time, generating a second magnetic field and a second electric field in the second treatment region, wherein a direction of the second magnetic field and a direction of the second electric field are substantially orthogonal with respect to one another within the second treatment region.” Blocks 606 and 608 may be implemented by driving first and second resonant circuits at their resonant frequencies, using signals that are out of phase with one another. For example, the first resonant circuit may include a first inductive element positioned to provide a magnetic field in the first treatment region and a first capacitance positioned to provide an electric field in the second treatment region. The second resonant circuit may include a second inductive element positioned to provide a magnetic field in the second treatment region and a second capacitance positioned to provide an electric field in the first treatment region. A controller may apply out-of-phase (e.g. 90 degrees out-of-phase) signals to the first and second resonant circuits such that peak electric and magnetic fields are provided simultaneously in the first treatment region, while at a different time, peak electric and magnetic fields are provided simultaneously in the second treatment region. The signals used may be any periodic signals, including but not limited to, sine waves, triangle waves, pulses, and combinations thereof.

Block 610 recites, “sensing magnetic fields and/or electric fields in the first and second treatment regions.” One or more sensors may be provided to sense the field strength in the treatment regions. The magnitude and time of the peak magnetic and electric fields may be monitored, for example, utilizing processors, controllers, or other computing devices described herein.

Block 612 recites, “dynamically adjusting drive signals used to generate the magnetic fields and electric fields in the first and second treatment regions, wherein the first signal causes the generation of the first magnetic field and the generation of the second electric field, and wherein the second signal causes the generation of the second magnetic field and the first electric field.” The adjustment made be made by processors, controllers, or other computing devices described herein. The magnitude, frequency, and/or phase of signals provided to the resonant circuits described herein may be adjusted. For example, the peak magnetic and electric fields are not occurring substantially simultaneously in the treatment regions, the phase between the signals provided to the resonant circuits may be changed to improve the coincidence of the peak electric and magnetic fields. If insufficient field strength for the desired pasteurization is found, the magnitude of signals provided to the resonant circuits may be increased. In some examples, if a temperature is exceeded in one or both of the treatment regions, the magnitude of the signals provided to the resonant circuit(s) may be decreased.

The method 600 may be implemented to sufficiently pasteurize liquid foods. For example, peak electric and magnetic fields in the first and second may be induced at a sufficient level to kill bacteria present in the liquid foods. In some examples, due to the synergistic effect of the simultaneous presence of electric and magnetic fields, the field strength to kill a population of bacteria may be less than required if electric or magnetic fields had been used alone or sequentially.

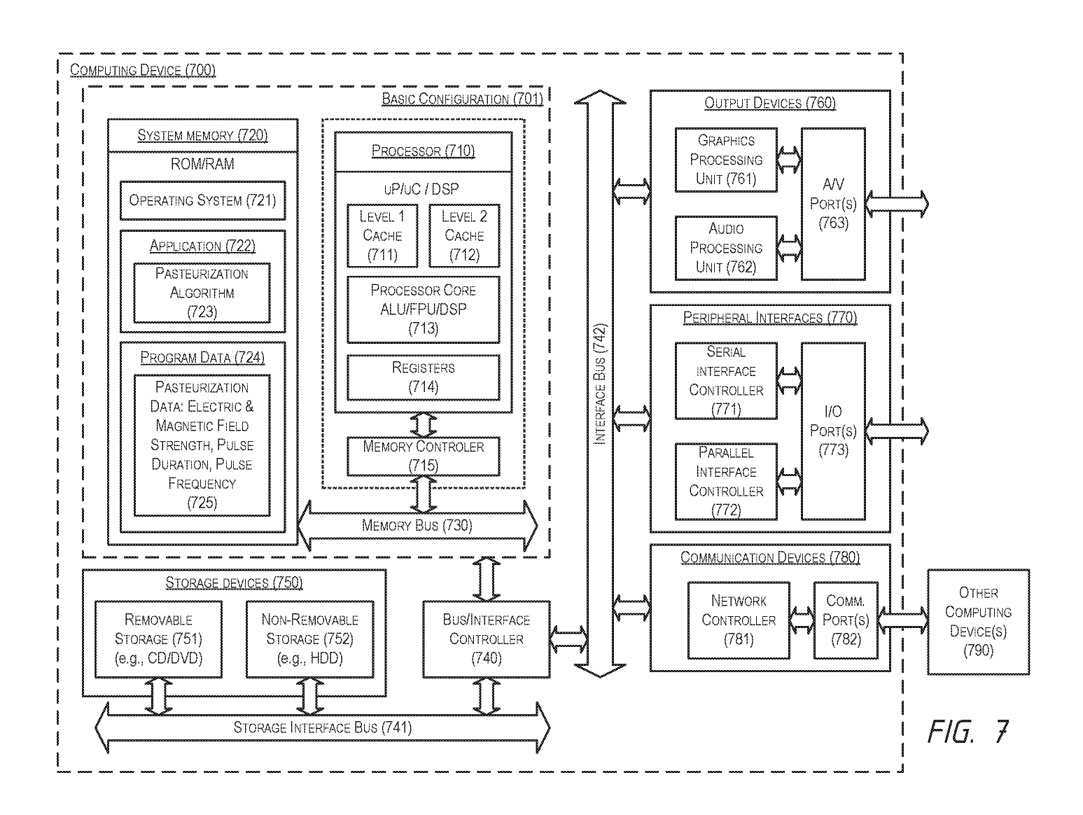

FIG. 7 is a block diagram illustrating an example computing device 700 that is arranged for controlling a pasteurization system in accordance with at least some embodiments described herein. In a very basic configuration 701, computing device 700 typically includes one or more processors 710 and system memory 720. A memory bus 730 may be used for communicating between the processor 710 and the system memory 720.

Depending on the desired configuration, processor 710 may be of any type including but not limited to a microprocessor (μP), a microcontroller (μC), a digital signal processor (DSP), or any combination thereof. Processor 710 may include one more levels of caching, such as a level one cache 711 and a level two cache 712, a processor core 713, and registers 714. An example processor core 713 may include an arithmetic logic unit (ALU), a floating point unit (FPU), a digital signal processing core (DSP Core), or any combination thereof. An example memory controller 715 may also be used with the processor 710, or in some implementations the memory controller 715 may be an internal part of the processor 710.

Depending on the desired configuration, the system memory 720 may be of any type including but not limited to volatile memory (such as RAM), non-volatile memory (such as ROM, flash memory, etc.) or any combination thereof. System memory 720 may include an operating system 721, one or more applications 722, and program data 724. Application 722 may include a pasteurization procedure 723 that is arranged to operate a pasteurization system as described herein, such as the pasteurization system 200 of FIG. 2. Program data 724 may include pasteurization data 725, desired electric and/or magnetic field strength and/or duration, and/or other information useful for the implementation of a pasteurization system as described herein. For example, the program data 724 may control a pasteurization based on the type of liquid food being treated, a set flow rate, an acceptable temperature range, a desired PEF and PMF peak values. In some embodiments, application 722 may be arranged to operate with program data 724 on an operating system 721 such that any of the procedures described herein may be performed. This described basic configuration is illustrated in FIG. 7 by those components within dashed line of the basic configuration 701.

Computing device 700 may have additional features or functionality, and additional interfaces to facilitate communications between the basic configuration 701 and any required devices and interfaces. For example, a bus/interface controller 740 may be used to facilitate communications between the basic configuration 701 and one or more storage devices 750 via a storage interface bus 741. The storage devices 750 may be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 720, removable storage 751 and non-removable storage 752 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 742 for facilitating communication from various interface devices output interfaces, peripheral interfaces, and communication interfaces) to the basic configuration 701 via the bus/interface controller 740. Example output devices 760 include a graphics processing unit 761 and an audio processing unit 762, which may be configured to communicate to various external devices such as a display or speakers via one or more A/V ports 763. Example peripheral interfaces 750 include a serial interface controller 771 or a parallel interface controller 772, which may be configured to communicate with external devices such as input devices (e.g., keyboard, mouse, pen, voice input device, touch input device, etc.) or other peripheral devices (e.g., printer, scanner, etc.) via one or more I/O ports 773. An example communication device 780 includes a network controller 781, which may be arranged to facilitate communications with one or more other computing devices 790 over a network communication ink via one or more communication ports 782.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

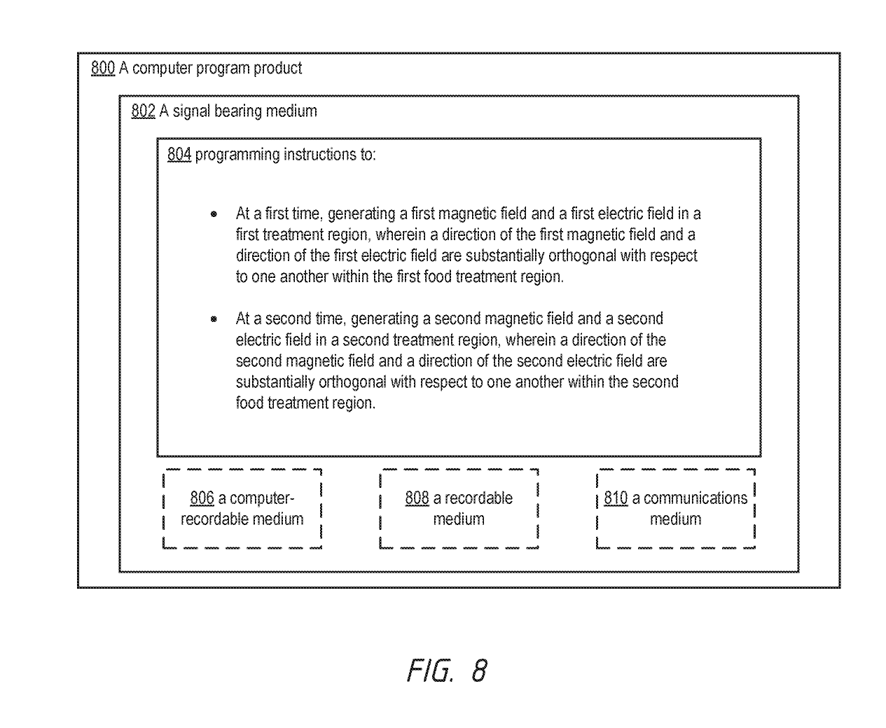

FIG. 8 is a block diagram illustrating an example computer program product 800 that is arranged to store instructions for a pasteurization system in accordance with at least some embodiments described herein. The signal bearing medium 802 which may be implemented as or include a computer-readable medium 806, a computer recordable medium 808, a computer communications medium 810, or combinations thereof, stores programming instructions 804 that may configure the processing unit to perform all or some of the processes previously described. These instructions may include, for example, one or more executable instructions for causing a pasteurization system to at a first time, generate a first magnetic field and a first electric field in a first food treatment region, wherein the first magnetic field and the first electric field are transverse within the first food treatment region, and at a second time, generate a second magnetic field and a second electric field in a second food treatment region, wherein the second magnetic field and the second electric field are transverse within the second food treatment region.

In some examples, a system comprises a chamber, the chamber comprising a conduit configured to receive a liquid. Other containers may be used in other examples, such as, but not limited to, a vat or vessel. The chamber may be associated with an inductive element and a capacitive element. The inductive element may be configured to provide a magnetic field to a liquid as the liquid passes through the conduit. The capacitive element may be configured to provide an electric field to the liquid as it passes through the conduit. Areas of orthogonal capacitive and inductive fields may form a treatment region, which may be entirely or partially contained within the conduit.

In some examples, the inductive element may comprise a coil, such as an electrically conductive coil which provides the magnetic field when the coil is energized by a first drive signal. In some examples, the capacitive element may comprise a pair of electrical conductors having a gap there between, the liquid at least in part flowing through the gap. In some examples, a system may further include a second chamber which may be implemented as a conduit or other container to receive a second liquid for pasteurization. The second chamber may be associated with a second inductive element and a second capacitive element, the second inductive element and the second capacitive element configured to provide magnetic and electric fields to the second liquid, respectively. Areas of orthogonal capacitive and inductive fields may form a treatment region, which may be entirely or partially contained within the conduit. In some examples, a system comprises a conduit, which may be configured to receive a fluid, such as a liquid, foam, suspension, powder, and the like. A system may comprise an inductive element configured to apply a magnetic field an interior portion of the conduit, for example to the liquid as the liquid passes through the conduit. In some examples, a conduit may be elongated and have at least locally) a central axis, and a magnetic field may be configured to extend at least in part along a central axis of the conduit. A system may further comprise a capacitive element configured to apply an electric field to an interior portion of the conduit, for example to the liquid as the liquid passes through the conduit. The magnetic field and the electric field may be orthogonal within at least a portion of the liquid. An electric field may be radial electric field, for example using a conductive element at the center of the conduit. A system may further comprise a control circuit configured to provide a first signal to the inductive element to apply the magnetic field, and configured to provide a second signal to the capacitive element to apply the electric field. The control circuit may be configured so that the electric field and the magnetic field oscillate substantially in phase with each other within the liquid.

In some examples, an inductive element may comprise a coil, such as a solenoid, the conduit passing through an interior portion of the coil. For example, a coil may be wound around the conduit, or wound around a central portion through which the conduit extends. The coil may be an electromagnetic when energized by the control circuit.

In some examples, a capacitive element may comprise first and second electrically conductive elements, the conduit passing between the first and second electrically conductive elements. In some examples, a capacitive element comprises a first electrically conductive element extended along a central axis of the conduit, and a second electrically conductive element exterior to the conduit, adjacent or proximate an exterior wall of the conduit, or providing an exterior wall of the conduit.

In some examples, a system may further comprise a second inductive element and a second capacitive element, wherein the second capacitive element is electrically coupled to the inductive element to form a first resonant circuit, and the second inductive element is electrically coupled to the capacitive element to form a second resonant circuit. A system may comprise a second conduit configured to receive a second liquid, wherein the second inductive element is configured to apply a second magnetic field to the second liquid as the second liquid passes through the second conduit, and the second capacitive element is configured to apply a second electric field to the second liquid as the second liquid passes through the second conduit.

In some examples, a system comprises a first conduit; a first inductive element configured to provide a first magnetic field to the first conduit (for example to an interior portion of the first conduit, in which for example a liquid may be present, for example as a flow of liquid); a first capacitive element configured to provide a first electric field to the first conduit (for example to an interior portion of the first conduit, in which for example a liquid may be present, for example as a flow of liquid); a second conduit; a second inductive element configured to provide a second magnetic field to the second conduit (for example to an interior portion of the second conduit, in which for example a second liquid may be present, for example as a second flow of liquid); and a second capacitive element configured to provide a second electric fields to the second conduit (for example to an interior portion of the second conduit, in which for example a second liquid may be present, for example as a second flow of liquid). The first capacitive element may be coupled to the second inductive element to form a first resonant circuit, and the second capacitive element may be coupled to the first inductive element to form a second resonant circuit. A controller may be configured to provide a first signal to the first resonant circuit and a second signal to the second resonant circuit. The first signal and the second signal may be substantially or essentially out of phase.

In some examples, a method, such as a method of pasteurizing (or otherwise reducing the contamination of a liquid), comprises applying a magnetic field and an electric field to the liquid, wherein the magnetic field is an oscillating magnetic field, and the electric field is an oscillating electric field, and wherein the magnetic field and the electric field are substantially orthogonal within the liquid, and the magnetic field and the electric field are substantially in phase with each other. The magnetic field and electric field may be individually, and/or together, sufficient to pasteurize the liquid. In some examples, a method may further comprise applying a second magnetic field and a second electric field to a second liquid, wherein the second magnetic field is an oscillating magnetic field, and the second electric field is a second oscillating electric field, wherein the second magnetic field and the second electric field are substantially orthogonal within the second liquid, and the second magnetic field and the second electric field are substantially in phase with each other and out of phase with the magnetic field and the electric field.

In some examples, a fluid may be pasteurized using methods and/or apparatus described herein. A fluid may be, or comprise, a liquid, foam, slurry, suspension, flowing powder, micelles, and the like. A fluid may be, or comprise, milk, fruit juice, and/or a carbonated beverage. A fluid may be a multi-component food product such as ketchup, salsa, and the like.

In some examples, a fluid may be sterilized, pasteurized, partially pasteurized. Additional methods and apparatus may be combined with any described method and apparatus to achieve sterilization or pasteurization.

The present disclosure is not to be limited in terms of the particular examples described in this application, which are intended as illustrations of various aspects. Many modifications and examples can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and examples are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular examples only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third. etc. As will also be understood by one skilled in the art all language such as “up to;” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

While the foregoing detailed description has set forth various examples of the devices and/or processes via the use of block diagrams, flowcharts, and/or examples, such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one example, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the examples disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. For example, if a user determines that speed and accuracy are paramount, the user may opt for a mainly hardware and/or firmware vehicle; if flexibility is paramount, the user may opt for a mainly software implementation; or, yet again alternatively, the user may opt for some combination of hardware, software, and/or firmware.

In addition, those skilled in the art will appreciate that the mechanisms of the subject matter described herein are capable of being distributed as a program product in a variety of forms, and that an illustrative example of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While various aspects and examples have been disclosed herein, other aspects and examples will be apparent to those skilled in the art. The various aspects and examples disclosed herein are for purposes of illustration and are not intended to be limiting, with the true scope and spirit being indicated by the following claims.

what is claimed is:

1. A system to treat a first substance in a first treatment region and a second substance in a second treatment region, the system comprising:
a first resonant circuit that includes a first capacitive element coupled to a first inductive element;
a second resonant circuit that includes a second capacitive element coupled to a second inductive element;
wherein the first inductive element and the second capacitive element positioned about the first treatment region;
wherein the second inductive element and the first capacitive element are positioned about the second treatment region;
a controller coupled to the first and second resonant circuits and configured to provide a first signal to the first resonant circuit and a second signal to the second resonant circuit, wherein the first and second signals are phase shifted by a predetermined amount; and
wherein the controller is further configured to control the first signal effective to promote pasteurization of the first substance in the first treatment region, and also configured to control the second signal effective to promote pasteurization of the second substance in the second treatment region.

2. The system of claim 1, further comprising a first conduit extending through the first treatment region and configured to provide the first substance to the first treatment region.

3. The system of claim 2, wherein the second capacitive element is arranged around at least a portion of the first conduit, and wherein the first inductive element is arranged around the second capacitive element and around at least the portion of the first conduit.

4. The system of claim 2, wherein the first conduit comprises an inner portion having a central axis and an outer portion located about the central axis, and wherein the second capacitive element is configured as a coaxial capacitor having an inner conductor extending along at least a portion of the central axis of the first conduit and an outer conductor arranged around at least the outer portion of the first conduit.

5. The system of claim 2, wherein the second capacitive element is configured as a parallel plate capacitor comprising a first plate arranged on one side of at least a portion of the first conduit, and a second plate arranged at substantially an opposite side of at least the portion of the first conduit.

6. The system of claim 2, wherein the first conduit has a cross-sectional shape that is one of square, round, or elliptical.

7. The system of claim 2, wherein an inner portion of the first conduit is configured to facilitate flow of the first substance through the first treatment region.

8. The system of claim 2, further comprising a second conduit extending through the second treatment region and configured to provide the second substance to the second treatment region.

9. The system of claim 8, wherein the first capacitive element is arranged around at least a portion of the second conduit, and wherein the second inductive element is arranged around the first capacitive element and around at least the portion of the second conduit.

10. The system of claim 8, wherein the second conduit comprises an inner portion having a central axis and an outer portion located about the central axis, and wherein the first capacitive element is configured as a coaxial capacitor having an inner conductor extending along at least a portion of the central axis of the second conduit and an outer conductor arranged around at least the outer portion of the second conduit.

11. The system of claim 8, wherein the first capacitive element is configured as a parallel plate capacitor comprising a first plate arranged on one side of at least a portion of the second conduit, and a second plate arranged at substantially an opposite side of at least the portion of the second conduit.

12. The system of claim 8, wherein the second conduit has a cross-sectional shape that is one of square, round, or elliptical.

13. The system of claim 8, wherein the inner portion of the second conduit is configured to facilitate flow of the second substance through the second treatment region.

14. The system of claim 1, wherein the first inductive element and the second capacitive element are positioned about the first treatment region such that in response to first and second signals provided by the controller, a magnetic field is generated by the first conductive element in the first treatment region and an electric field is generated by the second capacitive element in the first treatment region.

15. The system of claim 14, wherein the magnetic field is substantially orthogonal to the electric field in the first treatment region.

16. The system of claim 15, wherein the magnetic field is at an angle of 89-91 degrees relative to the electric field in the first treatment region.

17. The system of claim 15, wherein the magnetic field is at an angle of 87-93 degrees relative to the electric field in the first treatment region.

18. The system of claim 15, wherein the magnetic field is at an angle of 86-94 degrees relative to the electric field in the first treatment region.

19. The system of claim 15, wherein the magnetic field is at an angle of 85-95 degrees relative to the electric field in the first treatment region.

20. The system of claim 14, wherein the magnetic field and the electric field in the first region are configured to reach maximum field strengths at substantially the same time.

21. The system of claim 14, wherein the second inductive element and the first capacitive element are positioned about the second treatment region such that in response to first and second signals provided by the controller, a magnetic field is generated by the second conductive element in the second treatment region and an electric field is generated by the first capacitive element in the second treatment region.

22. The system of claim 21, wherein the magnetic field is substantially orthogonal to the electric field in the second treatment region.

23. The system of claim 21, wherein the magnetic field and the electric field in the first region are configured to simultaneously reach maximum field strengths.

24. The system of claim 1, wherein the first and second signals are periodic signals, and wherein a phase shift between the first and second signals is about 90 degrees.

25. The system of claim 24, wherein in response to the first and second signals, the first inductive element and the second capacitive element are configured to simultaneously reach a maximum field strength within the first treatment region at a first time, and the second inductive element and the first capacitive element are configured to simultaneously reach a maximum field strength in the second treatment region at a second time, wherein the first time is different from the second time.

26. The system of claim 1, wherein the first and second conduits are coupled together such that the first and second substances are within fluid communication of one another.

27. The system of claim 1 further comprising a sensor that is coupled to the controller, wherein the sensor is positioned within one of the first treatment region or the second treatment region, wherein the sensor is configured to measure one of the magnetic field or the electric field within the corresponding one of the treatment regions.

28. A system to treat a substance, the system comprising:
a conduit configured to receive the substance;
a control circuit, wherein the control circuit is configured to selectively provide a first signal and a second signal;
an inductive element configured to selectively, in response to the first signal, apply a magnetic field to the substance in the conduit; and
a capacitive element configured to selectively, in response to the second signal, apply an electric field to the substance in the conduit.

29. The system of claim 28, wherein the inductive element comprises a coil, and wherein the conduit passes through an interior portion of the coil.

30. The system of claim 28, wherein the capacitive element comprises first and second electrically conductive elements, and wherein the conduit extends between the first and second electrically conductive elements.

31. The system of claim 28, wherein the capacitive element comprises a first electrically conductive element that extends along a central axis of the conduit.

32. The system of claim 31, wherein the capacitive element further comprises a second electrically conductive element forming an outer portion of the conduit.

33. The system of claim 31, wherein the capacitive element comprises a second electrically conductive element that is positioned proximate to a wall of the conduit.

34. The system of claim 31, further comprising a second inductive element and a second capacitive element, wherein
the second capacitive element is electrically coupled to the inductive element to form a first resonant circuit; and
the second inductive element is electrically coupled to the capacitive element to form a second resonant circuit.

35. The system of claim 34, further comprising a second conduit configured to receive a second substance, wherein:
the second inductive element is configured to selectively, in response to the second signal, apply a second magnetic field to the second substance as the second substance passes through the second conduit;
the second capacitive element is configured to selectively, in response to the first signal, apply a second electric field to the second liquid as the second liquid passes through the second conduit.

36. A system comprising:
a first conduit comprising a first cross-sectional shape that extends along a first axis that is centrally located with respect to the first cross-sectional shape;
a first inductive element configured to selectively generate a first magnetic field across the first cross-sectional shape of the first conduit;
a first capacitive element configured to selectively generate a first electric field across the first cross-sectional shape of the first conduit;
a second conduit comprising a second cross-sectional shape that extends along a second axis that is centrally located with respect to the second cross-sectional shape;
a second inductive element configured to selectively generate a second magnetic field across the second cross-sectional shape of the second conduit;
a second capacitive element configured to selectively generate a second electric fields across the second cross-sectional shape of the second conduit,
wherein the first capacitive element is coupled to the second inductive element to form a first resonant circuit, and the second capacitive element is coupled to the first inductive element to form a second resonant circuit such that the first and second resonant circuits are cross-coupled with respect to the first and second conduits; and
a controller coupled to the first and second resonant circuits via first and second signals, respectively, wherein the controller is configured to selectively activate the first resonant circuit responsive to a first signal, and also to selectively activate the second resonant circuit responsive to a second signal.

37. The system of claim 36, wherein the controller is configured to generate the first signal and the second signal such that the first and second signals are substantially out of phase.

38. The system of claim 37, wherein the and second signals are out of phase by 90 degrees.

39. The system of claim 36, further comprising a first sensor arranged within the first conduit and coupled to the controller, wherein the sensor is configured to measure a magnetic field strength or an electric field strength, and provide feedback regarding the same.

40. The system of claim 36, further comprising a second sensor arranged within the second conduit and coupled to the controller, wherein the sensor is configured to measure a magnetic field strength or an electric field strength, and provide feedback regarding the same.

41. A method of treating a substance, the method comprising:
at a first time, generating a first magnetic field and a first electric field in a first treatment region, wherein a direction of the first magnetic field and a direction of the first electric field are substantially orthogonal with respect to one another within the first treatment region; and
at a second time, generating a second magnetic field and a second electric field in a second treatment region, wherein a direction of the second magnetic field and a direction of the second electric field are substantially orthogonal with respect to one another within the second treatment region.

42. The method of claim 41, wherein generating the first magnetic field and the first electric field comprises generating the first magnetic field and the first electric field such that they are at an angle of 89-91 degrees relative to one another.

43. The method of claim 41, wherein generating the first magnetic field and the first electric field comprises generating the first magnetic field and the first electric field such that they are at an angle of 88-92 degrees relative to one another.

44. The method of claim 41, wherein generating the first magnetic field and the first electric field comprises generating the first magnetic field and the first electric field such that they are at an angle of 87-93 degrees relative to one another.

45. The method of claim 41, wherein the first and second times are different.

46. The method of claim 41, wherein the first magnetic field and first electric field are out of phase with the second magnetic field and second electric field.

47. The method of claim 41, wherein generating a first magnetic field and a first electric field in a first treatment region and generating a second magnetic field and a second electric field in the second treatment region comprises:
providing a first signal to a first resonant circuit, wherein the first resonant circuit comprises a first inductive element arranged to generate the first magnetic field in the first treatment region and a first capacitive element arranged to generate the second electric field in the second treatment region; and
providing a second signal to a second resonant circuit, wherein the second resonant circuit comprises a second capacitive element arranged to generate the first electric field in the first treatment region and a second inductive element arranged to generate the second magnetic field in the second treatment region,
wherein the first and second signals are 90-degrees out of phase.

48. The method of claim 47, wherein the first and second resonant circuits have the same resonant frequencies.

49. The method of claim 42 further comprising:
sensing a first magnetic field strength and a first electric field strength in the first treatment region;
providing feedback based on values of the sensed first magnetic field strength and the sensed first electric field strength in the first treatment region; and
dynamically adjusting the first or second signals used to generate the first magnetic field and the first electric field in the first treatment region based on the feedback.

50. The method of claim 42, further comprising flowing the substance through one or more of the first or second food treatment regions.

51. A method of pasteurizing a substance, the method comprising:
applying a magnetic field and an electric field to the substance,
wherein the magnetic field is an oscillating magnetic field, and the electric field is an oscillating electric field.
wherein the magnetic field and the electric field are substantially in phase with each other,
wherein the magnetic field and electric field are together sufficient to pasteurize the substance.

52. The method of claim 51, wherein applying a magnetic field and an electric field to the substance comprises:
generating the magnetic field by an inductive element of a first resonant circuit; and
generating the electric field by a capacitive element of a second resonant circuit.

53. The method of claim 52, wherein generating the magnetic field by an inductive element of a first resonant circuit comprises providing the first resonant circuit with a first oscillation signal.

54. The method of claim 52, wherein generating the electric field by a capacitive element of a second resonant circuit comprises providing the second resonant circuit a second oscillation signal out of phase with the first oscillation signal.

55. The method of claim 51, further comprising:
flowing the substance through a treatment region, wherein the treatment region is defined by a volume of space where the magnetic field and the electric field are substantially orthogonal within the substance, and the magnetic field and the electric field are substantially in phase with each other.
